(19) United States
(12) Patent Application Publication
(10) Pub. No.: US 2014/0082491 A1
(43) Pub. Date: Mar. 20, 2014

(54) ELECTRONIC DEVICE AND EDITING METHOD FOR SYNTHETIC IMAGE

(71) Applicant: Panasonic Corporation, Osaka (JP)

(72) Inventors: Yusuke ADACHI, Osaka (JP); Naoto YUMIKI, Osaka (JP); Koji FUJII, Osaka (JP)

(73) Assignee: Panasonic Corporation, Osaka (JP)

(21) Appl. No.: 14/086,763

(22) Filed: Nov. 21, 2013

Related U.S. Application Data
(63) Continuation of application No. PCT/JP2012/003436, filed on May 25, 2012.

(30) Foreign Application Priority Data
May 26, 2011 (JP) 2011-117596

(51) Int. Cl. G06F 3/0484; G06F 3/01

(52) U.S. Cl. CPC G06F 3/04845; G06F 3/016
USPC 715/702; 715/765

(57) ABSTRACT

The electronic device includes: a display device capable of displaying a captured image and an item image; a touch screen panel for accepting an operation by a user; and a control circuit for calculating a displayed position and a displayed size for the item image based on a position and a size of a reference object in the captured image, generating a synthetic image in which the item image is merged with the captured image, and causing the display device to display the synthetic image, the control circuit generating a synthetic image in which the displayed position and displayed size of the item image are adjusted in accordance with an operation on the touch screen panel by the user.

This is a continuation of International Application No. PCT/JP2012/003436, with an international filing date of May 25, 2012, which claims priority of Japanese Patent Application No. 2011-117596, filed on May 26, 2011, the contents of which are hereby incorporated by reference.

### BACKGROUND

1. Technical Field

The present disclosure relates to an electronic device which permits touch operation by a user, for example.

2. Description of the Related Art

Prior to buying a large piece of furniture or home appliance item, one would desire advance knowledge as to whether the piece will have a size and coloration suitable to the room atmosphere, thus being harmonious with the room. One technique that satisfies such a desire employs an Augmented Reality technique. By merging an image of a piece of furniture or home appliance item to be purchased with an actually-taken image of a room, the user is able to confirm whether the furniture or home appliance would fit the room.

In Japanese Laid-Open Patent Publication No. 2010-287174, a marker is placed in a room to be shot, and an image of a range containing that marker is captured with a camera. Then, by merging an image of a piece of furniture to be purchased with the captured image, the user is able to previously confirm the size and the like of the furniture.

### SUMMARY

The prior art technique in connection with the Augmented Reality technique needs further improvement in view of operability. One non-limiting, and exemplary embodiment provides an electronic device which allows a merged position of an item image to be easily changed within a synthetic image.

An electronic device according to one embodiment of the present disclosure comprises: a display device capable of displaying a captured image and an item image; a touch screen panel configured to accept an operation by a user; and a control circuit configured to calculate a displayed position and a displayed size for the item image based on a position and a size of a reference object in the captured image, configured to generate a synthetic image in which the item image is merged with the captured image, and configured to cause the display device to display the synthetic image, the control circuit generating a synthetic image in which the displayed position and displayed size of the item image are adjusted in accordance with an operation on the touch screen panel by the user.

In one embodiment, the electronic device further comprises a tactile sensation unit configured to present a tactile information to the user in accordance with an operation by the user.

In one embodiment, the reference object is a marker containing marker information which is associated with the item image, the electronic device further comprising: a storage section storing the marker information and item image information containing the item image.

In one embodiment, the marker information contains actual-size information of the marker; the item image information contains actual-size information of the item image; and the control circuit calculates a merging ratio based on a displayed size of the marker appearing on the display device and an actual size of the marker, and calculates a displayed position and a displayed size for the item image based on the merging ratio and the actual-size information of the item image.

In one embodiment, the control circuit calculates a displayed position and a displayed size of an object in the captured image based on a displayed position and the displayed size of the marker.

In one embodiment, when the displayed position of the item image in the synthetic image is changed based on an operation by the user, the control circuit controls the tactile sensation unit to present a tactile sensation to the user based on whether a threshold value is exceeded by a displayed position coordinate concerning the displayed position of the item image or not.

In one embodiment, the threshold value is calculated from a displayed position coordinate concerning the displayed position of an object in the captured image; and if the displayed position coordinate of the item image exceeds the threshold value, the control circuit controls the tactile sensation unit to present a tactile sensation to the user.

In one embodiment, the reference object is at least one object contained in the captured image, the electronic device further comprising a storage section storing reference object information concerning the reference object and item image information containing the item image.

In one embodiment, the reference object is at least one object contained in the captured image, the electronic device further comprising: an interface for accepting an input of actual-size data of the reference object; and a storage section storing the accepted actual-size data of the reference object and the item image information containing the item image.

In one embodiment, the reference object information contains actual-size information of the reference object; the item image information contains actual-size information of the item image; and the control circuit calculates a merging ratio based on a displayed size of the reference object appearing on the display device and an actual size of the reference object and calculates a displayed position and a displayed size for the item image based on the merging ratio and the actual-size information of the item image.

In one embodiment, the control circuit calculates a displayed position and a displayed size for another object in the captured image based on a displayed position and a displayed size of the reference object.

In one embodiment, the electronic device further comprises a tactile sensation unit configured to present a tactile information to the user in accordance with an operation by the user. When the displayed position of the item image in the synthetic image is changed based on an operation by the user, the control circuit controls the tactile sensation unit to present a tactile sensation to the user based on whether a threshold value is exceeded by a displayed position coordinate concerning the displayed position of the item image or not.

In one embodiment, the tactile sensation unit presents a tactile sensation to the user in accordance with change in the displayed size of the item image.

In one embodiment, the electronic device further comprises a tactile sensation unit configured to present a tactile information to the user in accordance with an operation by the user. The item image information contains weight information of the item; and the tactile sensation unit varies the tactile sensation presented to the user based on the weight information of the item.

In one embodiment, the captured image is an image composed of an image for a left eye and an image for a right eye which are captured with a stereo camera capable of stereophotography; the storage section stores parallax information which is calculated from the reference object in the image for the left eye and the reference object in the image for the right eye; and the control circuit calculates a displayed position for the reference object based on the parallax information.

In one embodiment, the captured image is an image captured with an imaging device capable of detecting a focusing position of a subject, the subject including the reference object; the storage section stores distance information from the imaging device to the reference object, the distance information being calculated based on a focusing position of the reference object; and the control circuit calculates a displayed position for the reference object based on the distance information.

An editing method of a synthetic image according to one embodiment of the present disclosure comprises: calculating a displayed position and a displayed size for an item image based on a position and a size of a reference object in the captured image; generating a synthetic image by merging the item image in the captured image; causing the display device to display the synthetic image; and changing the displayed position and displayed size of the merged item image in accordance with an operation on the touch screen panel by the user.

In one embodiment, the method further comprises presenting a tactile sensation to the user based on the operation by the user.

According to the present disclosure, there is provided an electronic device portion which allows a merged position of a recording image to be easily changed within a synthetic image.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1A is a perspective view showing the appearance of an electronic device 10 at the display surface side.

FIG. 1B is a perspective view showing the appearance of the electronic device 10 at the rear side.

FIG. 2 is a block diagram showing the construction of the electronic device 10.

FIG. 3 is a cross-sectional view of the electronic device 10.

FIG. 4 is a perspective view of a vibrator 13 according to Embodiment 1.

FIGS. 5A and 5B are schematic illustrations showing exemplary vibration patterns in Embodiment 1.

FIG. 6 is a diagram showing a captured image (living room image) 51 obtained by shooting the inside of a room.

FIG. 7 is a diagram showing an example of a display screen in which an item image (television set image) 51 is displayed at the position of a marker 50.

FIG. 8 is a flowchart showing a flow of processes of the electronic device according to Embodiment 1.

FIG. 9 is a flowchart showing a flow of processes according to Embodiment 1.

FIG. 10 is a diagram showing an exemplary user operation in Embodiment 1.

FIG. 11 is an exemplary diagram showing an exemplary user operation in Embodiment 1.

FIG. 12 is a flowchart showing a flow of processes under the user operation described in FIG. 10.

FIG. 13 is a flowchart showing a flow of processes under the user operation (changing the size of an item) described in FIG. 11.

FIG. 14 is a diagram showing an exemplary user operation in Embodiment 1.

FIG. 15 is a flowchart showing a flow of processes under the user operation described in FIG. 14.

FIGS. 16A and 16B are diagrams showing an exemplary operation by a user in the present embodiment.

FIG. 17 is a flowchart showing a flow of processes under the user operation shown in FIGS. 16A and 16B.

FIGS. 18A and 18B are diagrams showing different vibration patterns in Embodiment 1.

FIG. 19 is a diagram showing an exemplary operation by a user in Embodiment 2.

FIG. 20 is a flowchart showing a flow of processes in Embodiment 2, where reference dimensions are input for image synthesis.

FIG. 21 is a schematic illustration showing a stereo camera 70 which is capable of stereophotography.

FIG. 22 is a flowchart showing a flow of processes according to Embodiment 3.

FIG. 23 is a diagram showing a captured image taken with the stereo camera 70.

FIG. 24 is a flowchart showing a flow of processes when conducting a simulation of carrying in a piece of furniture.

FIG. 25 is a diagram showing the subject distance between a digital camera 91 and a reference object (television set) 92.

FIG. 26 is a flowchart showing a flow of processes when using a depth map under an AF function.

FIG. 27 is a diagram showing an exemplary outdoor image, as a captured image.

### DETAILED DESCRIPTION

The confirmation of the position of a piece of furniture or the like is a task that often requires trial-and-error efforts. In the technique of Japanese Laid-Open Patent Publication No. 2010-287174, when it is desired to shift the position of an item that has once been merged, the user needs to change the position of the marker, and again capture an image of a range containing the marker with a camera. It is cumbersome to the user if such tasks need to be performed over again. Thus, under the conventional techniques, the ease with which to confirm harmony between an item and a room needs improvement.

Hereinafter, with reference to the attached drawings, electronic devices according to embodiments of the present disclosure will be described.

### Embodiment 1

Hereinafter, with reference to the drawings, an electronic device 10 according to the present embodiment will be described. The electronic device 10 described in Embodiment 1 is capable of displaying an image of an item to be purchased (e.g., an image of a television set) on a room image (e.g., an image of a living room) which was captured in advance, and easily change the displayed position, displayed size, or the like of the item image.

### <Explanation of Construction>

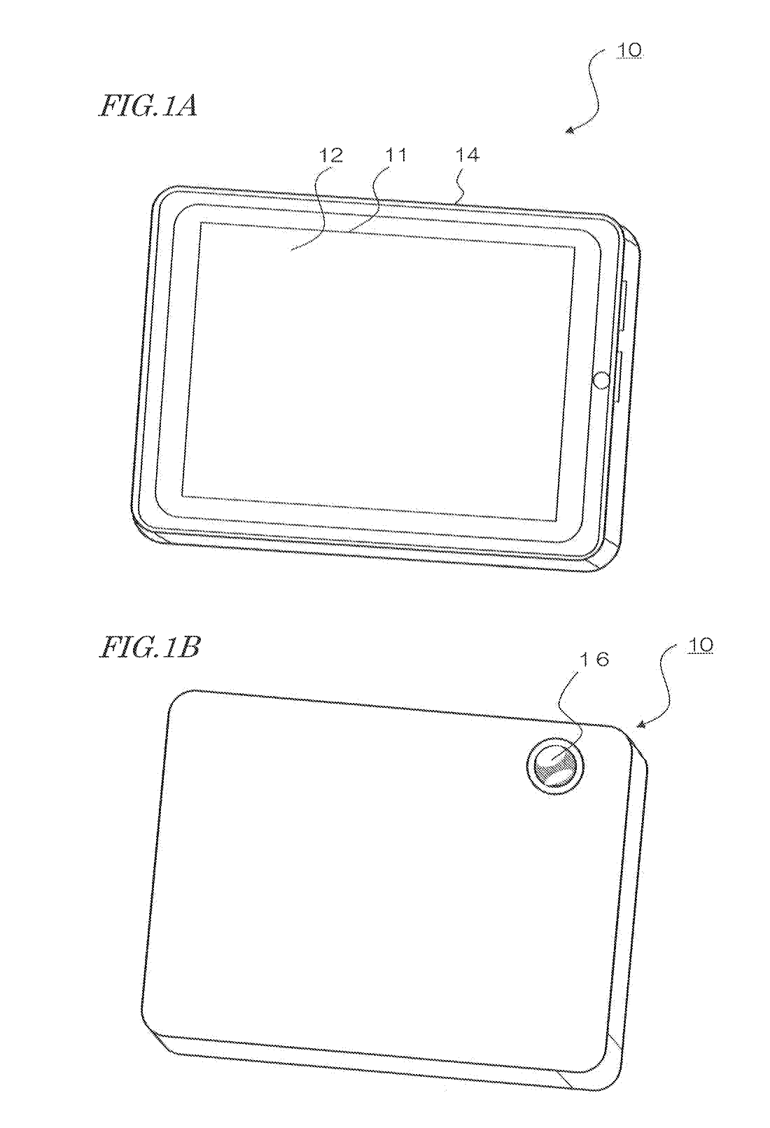

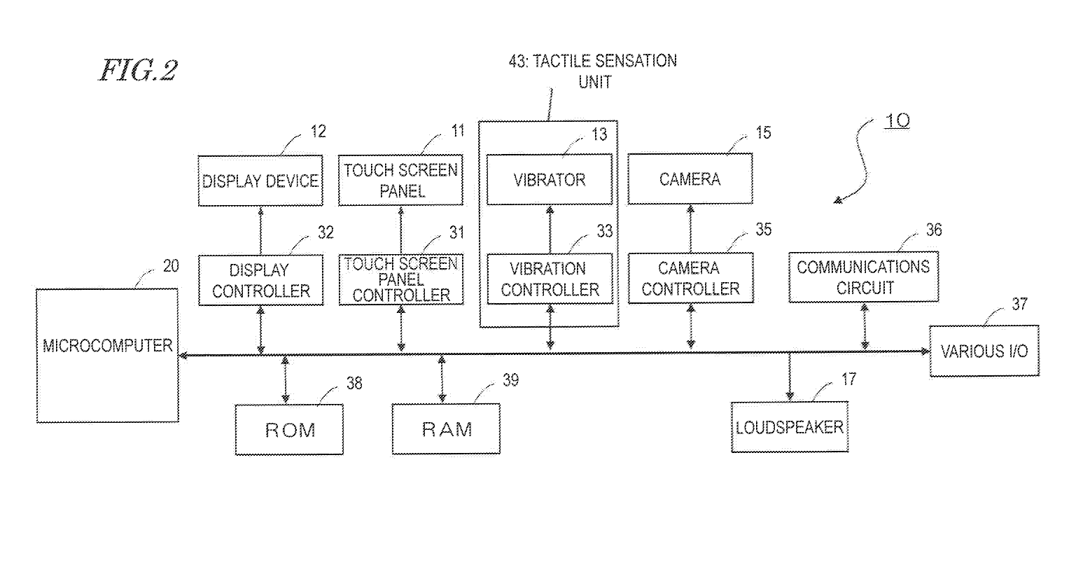

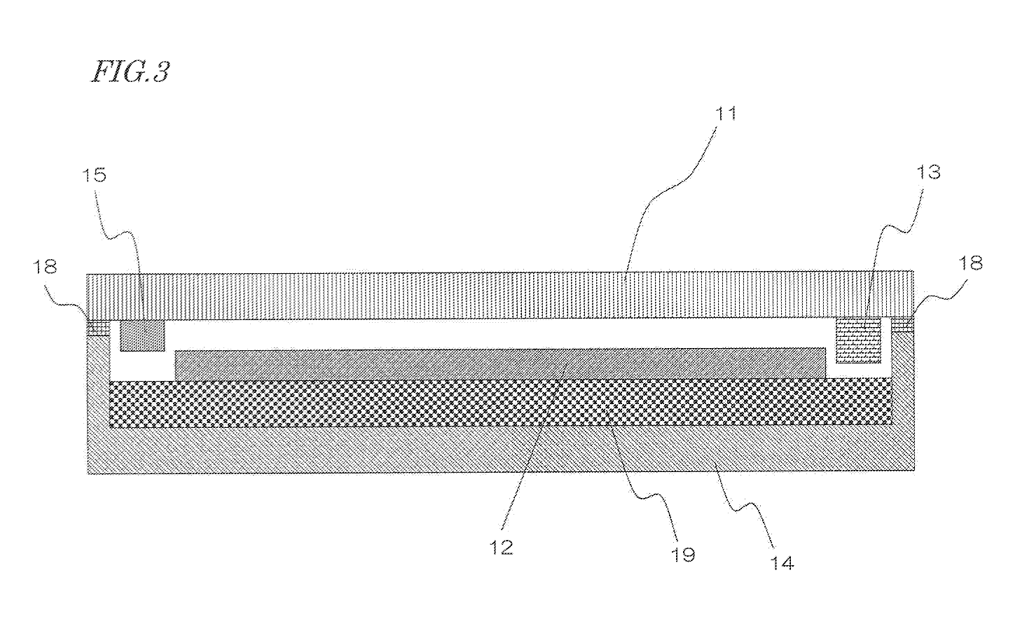

With reference to FIG. 1A, FIG. 1B, FIG. 2, and FIG. 3, the overall construction of the electronic device will be described.

FIG. 1A is a perspective view showing the appearance of the electronic device 10 at the display surface side, and FIG. 1B is a perspective view showing the appearance of the electronic device 10 at the rear side. As shown in FIG. 1A, the electronic device 10 includes a display device 12, a touch screen panel 11, and a housing 14. As shown in FIG. 1B, a lens 16 for camera shooting is provided at the rear side of the electronic device 10.

FIG. 2 is a block diagram showing the construction of the electronic device 10. FIG. 3 is a cross-sectional view of the electronic device 10.

As shown in FIG. 2, the electronic device 10 includes a display device 12, a display controller 32, a touch screen panel 11, a touch screen panel controller 31, a tactile sensation unit 43, a camera 15, a camera controller 35, a communications circuit 36, various communications means 37, a ROM 38, a RAM 39, and a microcomputer 20.

The display device 12 is capable of displaying a captured image and an item image. The display device 12 is able to display text, numbers, figures, a keyboard, etc. As the display device 12, any known display device such as a liquid crystal panel, an organic EL panel, an electronic paper, or a plasma panel can be used, for example.

Based on a control signal which is generated by the microcomputer 20, the display controller 31 controls what is displayed on the display device 12.

The touch screen panel 11 accepts a touch operation by a user. The touch screen panel 11 is disposed on the display device 12 so as to at least cover an operation area. Through a touch operation on the touch screen panel 11 with a finger, a pen, or the like, the user is able to operate the electronic device 10. The touch screen panel 11 is able to sense a position touched by the user. The information of the touched position of the user is sent to the microcomputer 20 via the touch screen panel controller 31. As the touch screen panel 11, a touch screen panel of an electrostatic type, a resistive membrane type, an optical type, an ultrasonic type, an electromagnetic type, or the like can be used, for example.

The microcomputer 20 is a control circuit (e.g., a CPU) which performs various processing described later by using information of the touched position of the user. Moreover, based on the position and size of a reference object within a captured image, the microcomputer 20 calculates a displayed position and a displayed size for an item image. Moreover, the microcomputer 20 generates a synthetic image by merging the item image into the captured image. Furthermore, the microcomputer 20 causes the synthetic image to be displayed by the display device 12. The microcomputer 20 is an example of control means. The “item image”, “reference object”, and “synthetic image” will be described later.

Furthermore, in accordance with the user's touch operation on the touch screen panel 11, the microcomputer 20 edits the displayed position and displayed size of the merged item image. The microcomputer 20 also functions as editing means.

In accordance with the user operation, the tactile sensation unit 43 presents tactile information for the user. In the present specification, the tactile information is presented in the form of a vibration, for example.

The tactile sensation unit 43 includes a vibrator 13 and a vibration controller 33.

The vibrator 13 causes the touch screen panel 11 to vibrate. The vibrator 13 is an example of a mechanism which presents a tactile sensation to the user. The vibration controller 33 controls the vibration pattern of the vibrator 13. The construction of the vibrator 13 and the details of vibration patterns will be described.

The camera 15, which is mounted on the electronic device 10, is controlled by the camera controller 35. By using the camera 15 mounted on the electronic device 10, the user is able to capture a room image, e.g., that of a living room.

The communications circuit 36 is a circuit which enables communications over the Internet, or with a personal computer or the like, for example.

Moreover, the electronic device 10 includes loudspeakers 17 for generating audios, and various input/output sections 37 capable of handling input/output from or to various electronic devices.

FIG. 3 is a cross-sectional view of the electronic device 10. The touch screen panel 11, the display device 12, the vibrator 13, and a circuit board 19 are accommodated in the housing 14. On the circuit board 19, the microcomputer 20, the ROM 38, the RAM 39, various controllers, a power supply, and the like are disposed.

The ROM 38 and RAM 39 store electronic information. The electronic information may include the following information.

### Examples of Electronic Information:

program information of programs, applications, and so on;

characteristic data of a marker 50 (e.g., a pattern identifying the marker or dimension information of the marker);

data of a captured image taken with the camera 15;

item image data (e.g., information concerning the shape and dimensions of an item to be merged (a television set, etc.));

vibration waveform data in which a waveform with which to vibrate the vibrator 13 is recorded; and

information for identifying, from a captured image, the surface shape, softness, hardness, friction, and the like of the imaged object.

Note that the electronic information may include not only data which is previously stored in the device, but also information which is acquired through the communications circuit 36 via the internet or the like, or information which is input by the user.

The aforementioned “marker” is a predetermined pattern. An example of the pattern may be a question mark (“?”) which is surrounded by solid lines on four sides. The marker may be printed on a piece of paper by the user, for example, and is placed in the room.

Generally speaking, the ROM 38 is a non-volatile storage medium which keeps retention even while it is not powered. Generally speaking, the RAM 39 is a volatile storage medium which only retains electronic information while it is powered. Examples of volatile storage media are DRAMs and the like. Examples of non-volatile storage media are HDDs, semiconductor memories such as EEPROMs, and the like.

The vibrator 13, which is mounted on the touch screen panel, is able to present a tactile sensation to the user by vibrating the touch screen panel 11. The touch screen panel 11 is disposed on the housing 14 via a spacer 18, the spacer 18 making it difficult for vibrations on the touch screen panel 11 to be transmitted to the housing 14. The spacer 18 is a cushioning member of silicone rubber, urethane rubber, or the like, for example.

The display device 12 is disposed in the housing 14, and the touch screen panel 11 is disposed so as to cover the display device 12. The touch screen panel 11, the vibrator 13, and the display device 12 are each electrically connected to the circuit board 19.

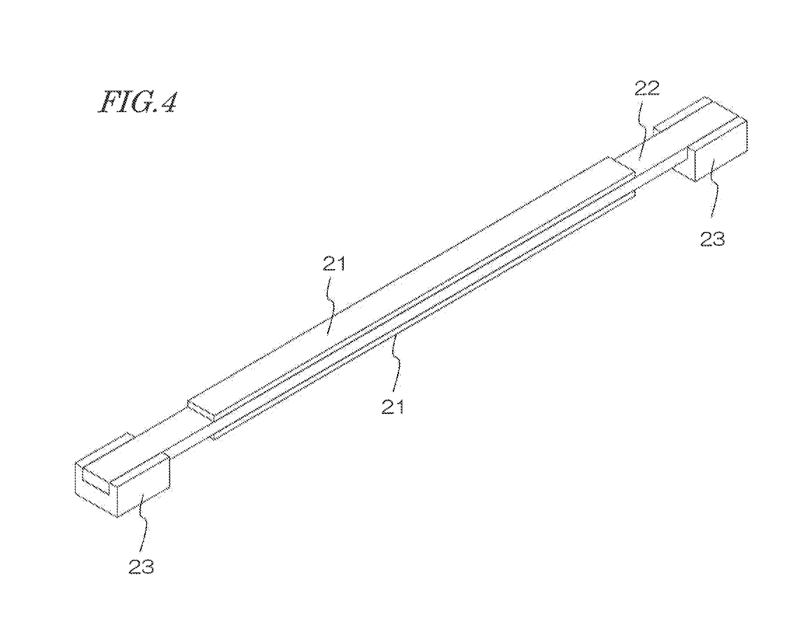

With reference to FIG. 4, the construction of the vibrator 13 will be described. FIG. 4 is a perspective view of the vibrator 13 according to the present embodiment. The vibrator 13 includes piezoelectric elements 21, a shim 22, and bases 23. On both sides of the shim 22, the piezoelectric elements 21 are adhesively bonded. Both ends of the shim 22 are connected to the bases 23, thus realizing a so-called simple beam structure. The bases 23 are connected to the touch screen panel 11.

The piezoelectric elements 21 are pieces of a piezoelectric ceramic such as lead zirconate titanate or a piezoelectric single crystal such as lithium niobate. With a voltage from the vibration controller 33, the piezoelectric elements 21 expand or contract. By controlling them so that one of the piezoelectric elements 21, attached on both sides of the shim 22, expands while the other shrinks, the shim 22 flexes; as a result of this, a vibration is generated.

The shim 22 is a spring member of e.g. phosphor bronze. The vibration of the shim 22 causes the touch screen panel 11 to vibrate via the base substrates 23, whereby the user operating the touch screen panel is able to detect the vibration of the touch screen panel.

The bases 23 are a metal such as aluminum or brass, or a plastic such as PET or PP.

The frequency, amplitude, and period of the vibration are controlled by the vibration controller 33. As the frequency of vibration, a frequency of about 100 to 400 Hz is desirable.

Although the present embodiment illustrates that the piezoelectric elements 21 are attached on the shim 22, the piezoelectric elements 21 may be attached directly onto the touch screen panel 11. In the case where a cover member or the like exists on the touch screen panel 11, the piezoelectric elements 21 may be attached on the cover member. Instead of piezoelectric elements 21, a vibration motor may be used.

### <Explanation of Vibration>

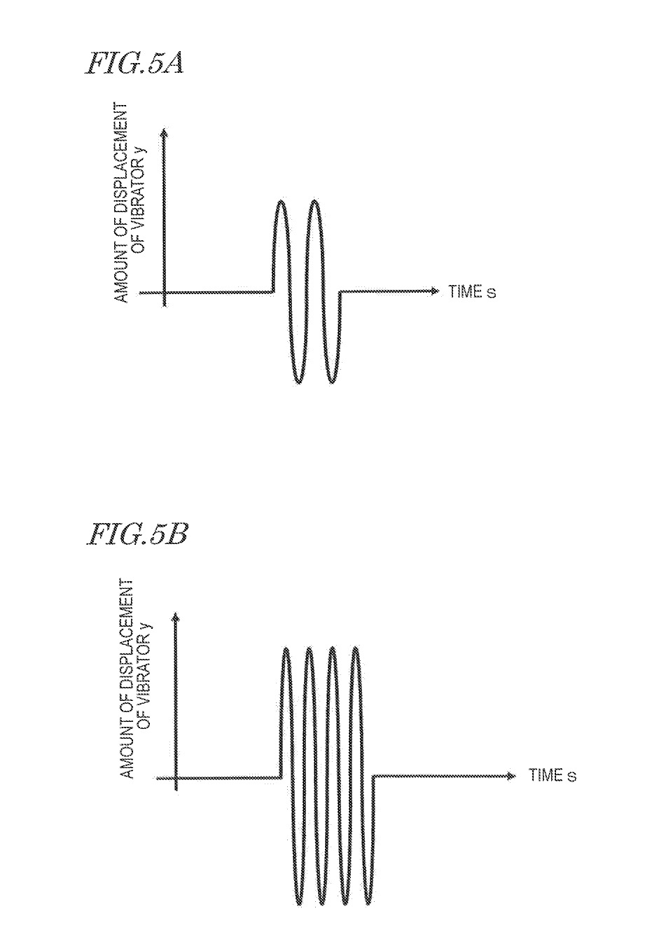

FIGS. 5A and 5B are a schematic illustration showing exemplary vibration patterns in Embodiment 1.

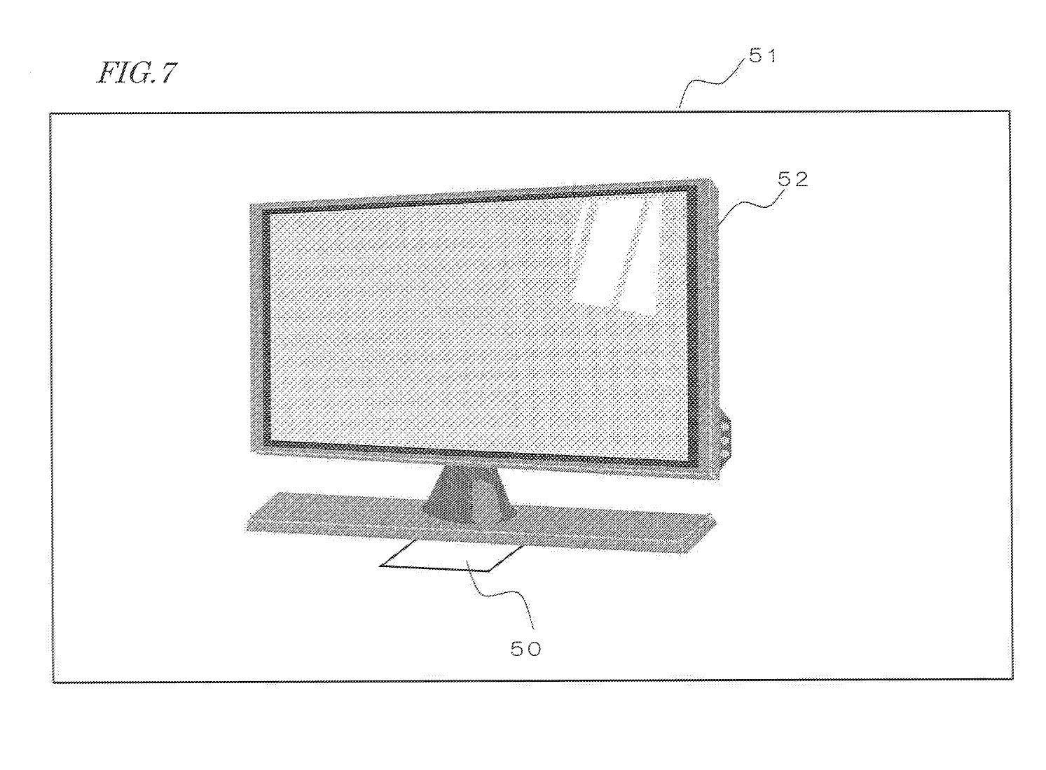

Based on an instruction from the microcomputer 20, the vibration controller 33 applies a voltage of a waveform as shown in FIG. 7(a) to the vibrator 13 to vibrate the touch screen panel 11. As a result, tactile sensation A is presented to the user. The voltage for presenting tactile sensation A is a sine wave of 150 Hz, 70 Vrms, and 2 cycles. In this case, there is about a 5 μm amplitude on the touch screen panel 11. Alternatively, the vibration controller 33 applies a voltage as shown in FIG. 7(b) to the vibrator 13 to vibrate the touch screen panel 11. As a result, tactile sensation B is presented to the user. The voltage for presenting tactile sensation B is a sine wave of 300 Hz, 100 Vrms, and 4 cycles. Note that the frequency, voltage, and number of cycles are examples; another waveform such as a rectangular wave, or a sawtooth wave, an intermittent waveform, a waveform with a gradually changing frequency or amplitude, etc., may also be used.

Although the present embodiment illustrates that tactile sensation A and tactile sensation B are different vibration patterns, this is not a limitation. Tactile sensation A and tactile sensation B may be of the same vibration pattern.

Now, it is assumed that the user is going to purchase a television set, and is considering where in the living room the television set is to be placed.

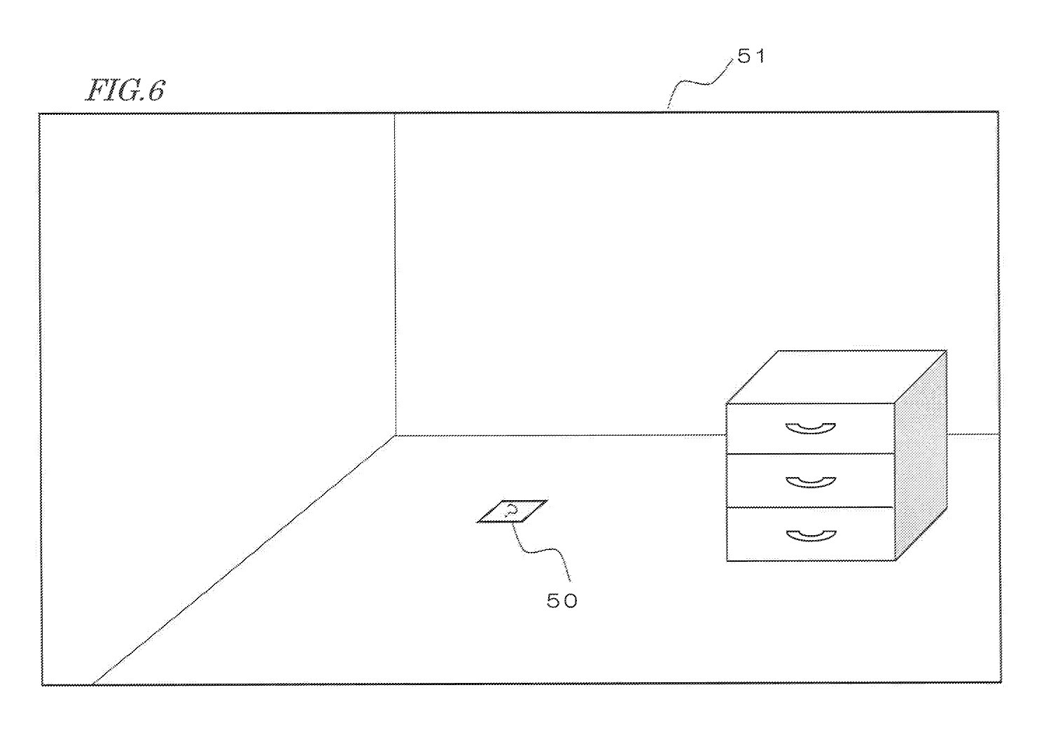

FIG. 6 is a diagram showing a captured image (living room image) 51 obtained by shooting the inside of a room. FIG. 6 is representative of a living room, for example. The user places a marker 50 at a position where he or she desires to place a television set to be purchased. By using the camera 15, the user captures an image of the living room so that the marker 50 fits within the captured range. An image of the television set to be purchased is displayed at the position of the marker within the captured image. The marker 50 is an example of a reference object.

Thus, the present embodiment is based on the premise that an augmented reality (which hereinafter may simply be referred to as AR) technique is employed.

FIG. 7 shows an example of a display screen, with an item image (television set image) 51 being displayed at the position of the marker 50. Thus, by using the AR technique, an imaginary image can be displayed in an actual image.

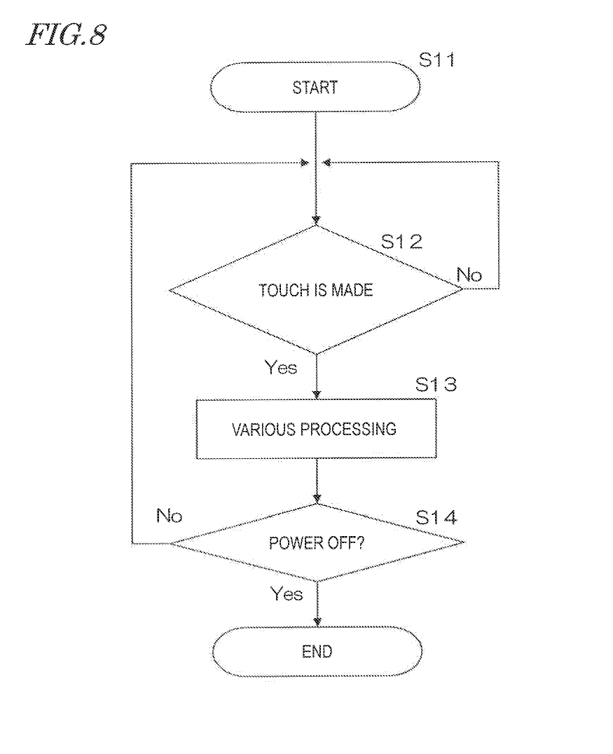

FIG. 8 is a flowchart showing a flow of processes of the electronic device of Embodiment 1, where S stands for step.

At S11, processing by the electronic device is begun. Specifically, the user turns on power, the program begins, and so on. Thereafter, at S12, the microcomputer 20 determines whether the user has touched the touch screen panel 11. For example, when the touch screen panel 11 is of an electrostatic capacitance type, the touch screen panel controller 31 detects a change in electrostatic capacitance. The touch screen panel controller 31 sends information concerning the detected change in electrostatic capacitance to the microcomputer 20. Based on the information which has been sent, the microcomputer 20 determines whether the user has made a touch or not. If no touch has been made (No from S12), the process again waits until a touch is made.

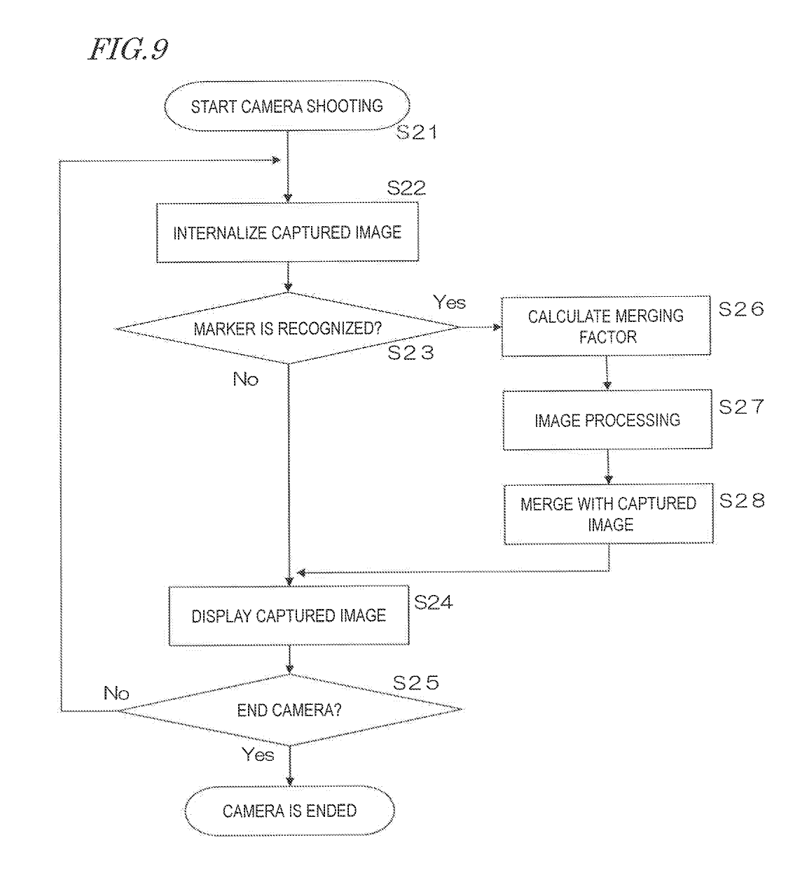

If a touch has been made (Yes from S12), various processing is performed at S13. The various processing includes processes concerning camera shooting, image manipulation by the user, displaying a captured image, and presenting a vibration. The various processing may consist of a single process; otherwise, a plurality of processes may occur consecutively, a plurality of processes may occur in parallel, or no processes may occur at all. Examples of such processing will be described in detail with reference to FIG. 9.

After the various processing of S13 is performed, the microcomputer 20 determines at S14 whether or not to end the process. Specifically, this may involve a power-OFF operation by the user, program ending, and so on.

FIG. 9 is a flowchart showing a flow of processes according to Embodiment 1. Specifically, it is a flowchart describing an example of “various processing (S13)” in the flowchart shown in FIG. 8.

At S21, camera shooting is begun.

Thereafter, at 822, data of a captured image taken with the camera 15 is sent via the camera controller 35 to the RAM 39, where it is stored.

Then at S23, the microcomputer 20 checks the captured image data against marker data which is previously recorded in the RAM 39. Thus, the microcomputer 20 determines whether the marker 50 is captured within the captured image (living room image) 51.

If it is determined that the marker 50 is not captured (No from S23), the process proceeds to S24. At S24, the microcomputer 20 causes the captured image data to be stored in the RAM 39 as display data. Then, the microcomputer 20 sends the display data to the display controller 20. Based on the display data which has been sent, the display controller 20 displays an image on the display device 12.

If it is determined that the marker 50 has been captured (Yes from S24), the process proceeds to 826.

At S26, based on the dimension information of the marker 50 and on item image data, which includes information concerning the shape and dimensions of the item to be merged (e.g., a television set to be purchased), the microcomputer 20 calculates a merging factor by which an item image (television set image) 52 is to be merged with the captured image (living room image) 51. Hereinafter, merging factor calculation will be specifically described.

First, based on the actual dimension data of the marker 50 and the dimension data of the marker 50 appearing in the captured image (living room image) 51, the microcomputer 20 calculates the sizes of objects (walls, furniture, etc.) which are in the captured image (living room image) 51, the depth of the room, and the like. Specifically, the microcomputer 20 calculates a ratio between the actual dimensions of the marker 50 and the dimensions of the marker 50 appearing in the captured image (living room image) 51. Moreover, the microcomputer 20 identifies the sizes of objects (walls, furniture, etc.) appearing in the captured image (living room image) 51. Then, based on the result of calculation and the identified object sizes, it calculates the actual sizes of the objects (walls, furniture identified) which are in the captured image (living room image) 51, the depth of the room, and the like. The ratio as calculated above is referred to as a merging factor 61. When displaying the item image (television set image) 52 in the captured image (living room image) 51 (living room), the size of the item image (television set image) 52 is determined based on this merging factor. The microcomputer 20 causes these results of calculation to be stored in the RAM 39.

The microcomputer 20 acquires marker coordinates indicating the position of the marker 50 within the captured image (living room image) 51, and causes them to be stored in the PAM 39.

Thereafter, the process proceeds to S27. At 327, based on the merging factor calculated at S26, the microcomputer 20 performs a recording image processing to enlarge or reduce the item image (television set image) 52. Then, data concerning the item image which has gone through the recording image processing is stored to the RAM 39. Hereinafter, the item image (television set image) 52 which has gone through the recording image processing will be referred to as the processed image 53. The processed image may be, for example, an enlarged or reduced television set image.

Thereafter, at S28, the microcomputer 20 merges the processed image (television set image) 53 at the marker 50 in the captured image (living room image) 52 based on the marker coordinates, and causes it to be stored in the RAM 39 as a display image.

Then, at S24, the display controller 32 causes the display image to be displayed by the display device 12.

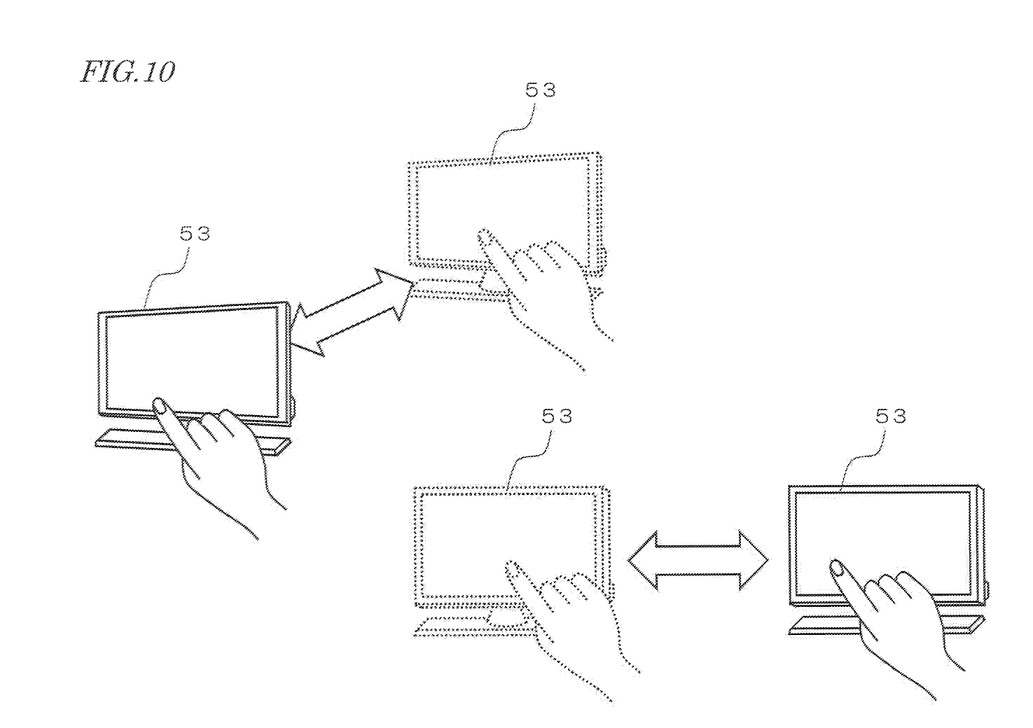

FIG. 10 is a diagram showing an exemplary user operation according to Embodiment 1.

A user who looks at the display image displayed on the display device 12 of the electronic device and thinks that the position of the processed image (television set image) 53 needs to be slightly shifted may perform the following operation.

First, the user touches the neighborhood of the processed image (television set image) 53 being displayed on the display device 12, and makes a swipe of a finger, in the direction in which the processed image (television set image) 53 is to be shifted. At this, the microcomputer 20 instructs the display controller 32 so that processed image (television set image) 53 being displayed is relatively moved against the display screen, by a displacement which corresponds to the detected finger displacement. By confirming the resultant image, the user is able to confirm the atmosphere of the room when the item takes a different position from the position where it was originally placed. If the finger swipe is in the horizontal direction against the display image, the processed image (television set image) 53 moves in the lateral direction. In that case, the processed image (television set image) 53 only undergoes a translation, without changing its size. For simplicity of explanation, the following description will say of the microcomputer 20 to be moving an image, changing the size, and so on. It must be noted that, in actuality, the microcomputer 20 gives an instruction to the display controller 32, upon which the display controller 32 performs a process of moving the displayed position of the image or a process of changing its size.

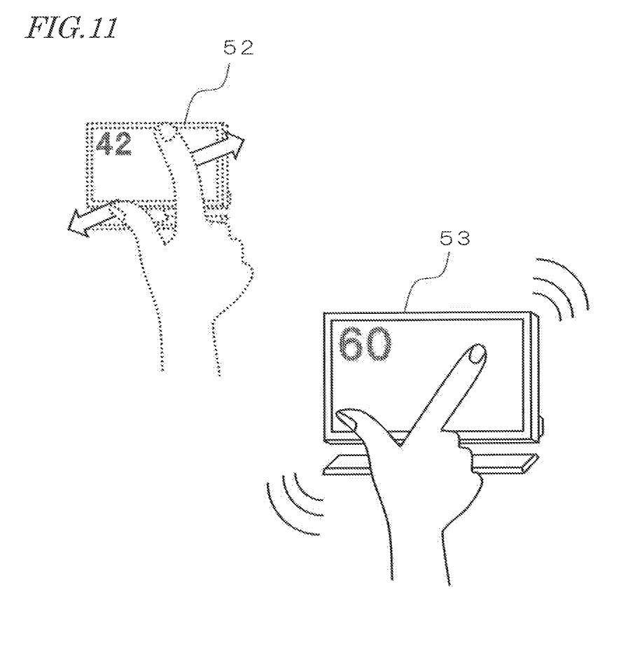

FIG. 11 is a diagram showing an exemplary user operation in Embodiment 1.

A user who looks at the image displayed on the display device 12 of the electronic device and thinks that the size of the processed image (television set image) 53 needs to be changed may perform the following operation.

The user touches the neighborhood of the processed image 53 being displayed on the display device 12 with a thumb and an index finger, and varies the interval between the two fingers. In accordance with an amount of change in the interval between the two fingers, the microcomputer 20 changes the size of the item. Hereinafter, this operation may be referred to as a “pinch operation”.

When the processed image 53 is a television set image, the size of the television set image is changed in accordance with the amount of change in the interval between the fingers. In the present embodiment, the size of the television set image is changed in steps, rather than going through continuous changes, so as to conform to the values of predefined sizes which are actually available on the market (e.g., 32″, 37″, 42″).

For example, if the amount of change in the interval between the fingers equals a predetermined value (α) or more, an image of a predefined size that is one grade larger may be displayed, and if the amount of change equals 2·α or more, an image of a predefined size that is two grades larger may be displayed. Similarly at reduction, if the amount of change in the interval between the fingers equals α or less, an image of a predefined size that is one grade smaller may be displayed, and if the amount of change equals 2·α or less, an image of a predefined size that is two grades smaller may be displayed.

The size value may also be indicated with the processed image (television set image) 53; as a result, the user will be able to know the size of the processed image (television set image) 53 which is currently displayed. Depending on the object which is represented by the processed image, the image size may be gradually changed, rather than in steps.

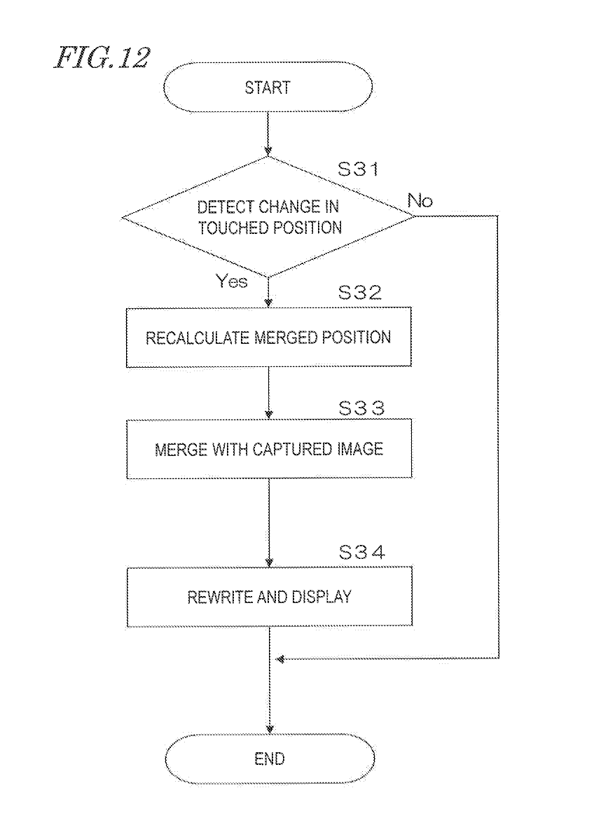

FIG. 12 is a flowchart showing a flow of processes under the user operation described with reference to FIG. 10.

First, at S31, the touch screen panel controller 31 detects a change in the touched position of the user.

If a change in the touched position is detected (Yes from S31), the process proceeds to S32. At S32, the microcomputer 20 receives the detected value of change in touched position from the touch screen panel controller 31. Based on the received value of change in touched position, the microcomputer 20 calculates a displacement of the user's finger. Then, the microcomputer 20 calculates a displacement for the processed image (television set image) 53 such that the displayed position of the item makes a move which is equal to the displacement of the user's finger. By adding the displacement of the processed image (television set image) 53 to the marker coordinates (i.e., the coordinates of the position at which the marker 50 is located), the microcomputer 20 calculates coordinates of a merged position. These values are stored to the RAM 39. Within the captured image, the microcomputer 20 merges the processed image (television set image) 53 at the coordinates of the merged position, thereby generating a display image. This is display image is stored to the RAM 39.

Thereafter, at S34, the display controller 32 controls the display device 12 so as to display the display image generated through the above process.

If no change in the touched position is detected (No from S31), the process proceeds to S35 and is ended.

Through the above process, the user is able to freely move the processed image (television set image) 53 within the bounds of the display device 12.

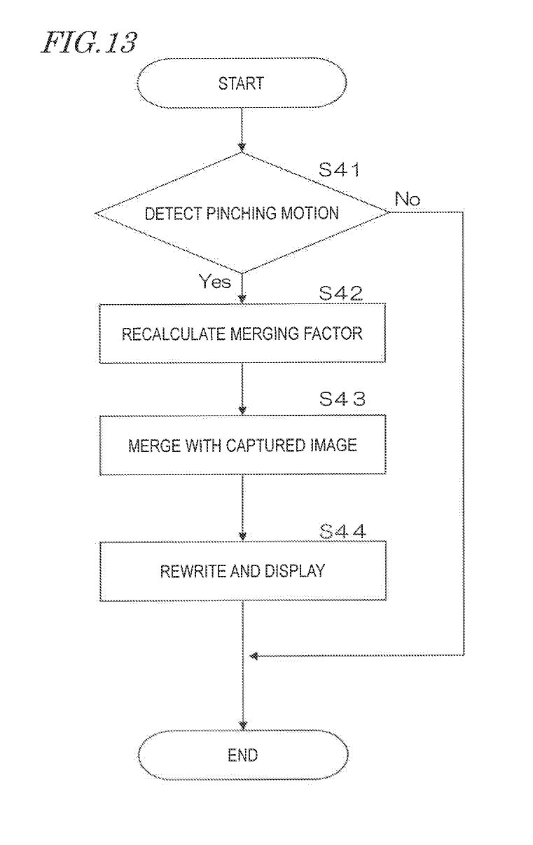

FIG. 13 is a flowchart showing a flow of processes under the user operation (changing the size of an item) described in FIG. 11.

First, at S41, the touch screen panel controller 31 detects an amount of change in touched position that is caused by a pinch operation by the user. For example, if the user touches with two fingers, followed by a change in the position of at least one of the two fingers, that amount of change is detected.

If a pinch operation is detected (Yes from S41), the process proceeds to S42. At S42, based on the amount of change in touched position detected by the touch screen panel controller 31, the microcomputer 20 calculates an amount of pinch. The amount of pinch indicates an amount of change in the interval between fingers during a pinch operation. Based on the finger interval when the user touches with two fingers, any broader finger interval is expressed as a larger amount of pinch, and any narrower finger interval is expressed as a smaller amount of pinch.

Based on the change in amount of pinch, the microcomputer 20 varies the merging factor (i.e., a rate of change in the displayed size of an item). Specifically, if the amount of pinch increases, the microcomputer 20 increases the merging factor; if the amount of pinch decreases, the microcomputer 20 decreases the merging factor. Based on the merging factor, the microcomputer 20 performs a process of enlarging or reducing the displayed size of the item image (television set image) 52, thus generating a processed image (television set image) 53. The merging may be performed so that the size value of the television set is indicated with the processed image (television set image) 53, thus allowing the user to know the item size. The merging factor value is stored to the RAM 39, and updated each time a pinch operation is performed. Then, the microcomputer 20 allows the processed image 53 which has gone through the process of enlarging or reducing to be merged at the marker coordinates of the captured image (living room image) 51, thereby generating a display image. This display image is stored to the RAM 39.

Next, at S44, the display controller 32 controls the display device 12 so as to display the display image generated through the above process.

If no change in the touched position is detected (No from S41), the process proceeds to S46 and is ended.

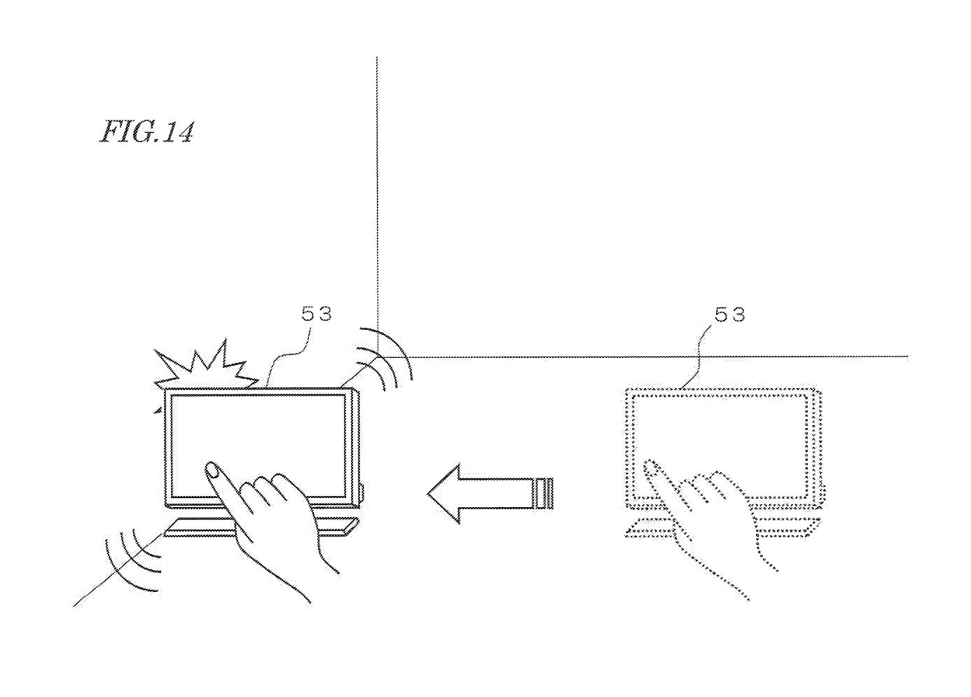

FIG. 14 is a diagram showing an exemplary user operation in Embodiment 1.

A user who looks at the display image displayed on the display device 12 and thinks that the position of the item needs to be shifted may perform the following operation.

The user touches the neighborhood of the processed image (television set image) 53 being displayed on the display device 12, and makes a swipe of 0.3 finger in the direction in which the processed image (television set image) 53 is to be shifted. The processed image (television set image) 53 is displayed on the display device 12 in a manner of following the finger swipe. For example, as shown in FIG. 14, if the user wishes to place an item by the wall, the user makes a finger swipe in the direction in which the wall exists, whereby the processed image (television set image) 53 also moves in the display image so as to follow the swipe operation. Once the end of the processed image (television set image) 53 hits the wall, the vibrator 13 vibrates to present a tactile sensation to the user.

This tactile sensation alarms the user that the processed image (television set image) 53 cannot be moved in the wall direction any farther. Without being limited to a tactile sensation such as vibration, this alarm may be in any form that can call the attention of the user, e.g., sound, light, or color change.

In order to determine whether the end of the processed image 53 has hit the wall, the positions of the end and the wall need to be identified, and a determination must be made whether the wall position and the end position coincide. The wall position may be identified by the user, for example, or any object in the image that matches a wall pattern that is previously retained in the RAM 39 may be recognized as a wall.

Alternatively, the microcomputer 20 may measure the distance between the end and the wall in the image and determine whether the distance is zero or not, thereby determining whether the end of the processed image 53 has hit the wall or not. Based on characteristic data (dimension information) of the marker 50 that is stored in the ROM 38 or the RAM 39, the microcomputer 20 may determine the distance from the marker to the wall as a distance between the end and the wall in the image.

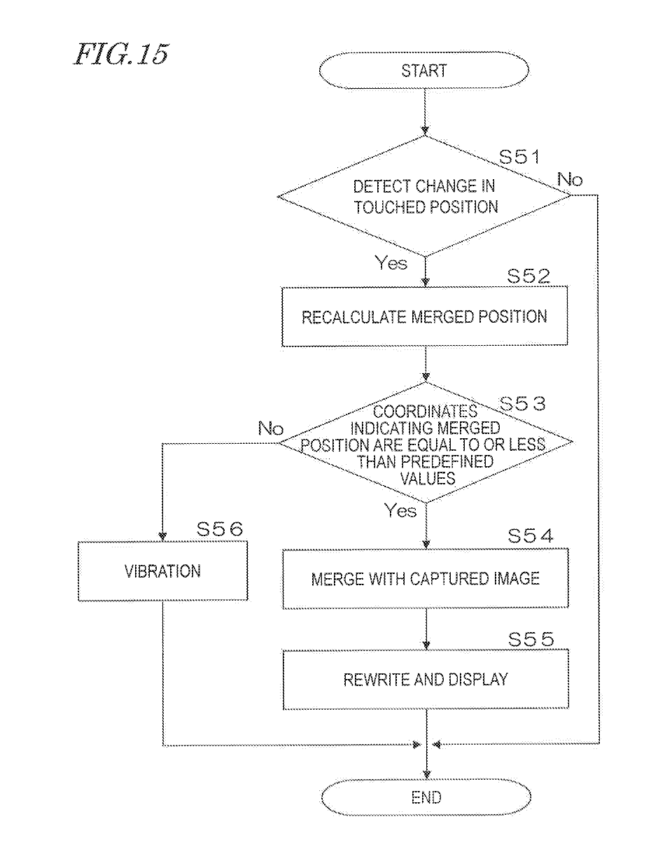

FIG. 15 is a flowchart showing a flow of processes under the user operation described in FIG. 14.

The process described herein is a process concerning the “various processing” at S13 of the flowchart shown in FIG. 8. If it is determined at S12 in the flowchart shown in FIG. 8 that the user has made a touch, the process proceeds to S51. At S51, a change in the touched position of the user is detected. Specifically, the touched position of the user on the touch screen panel 11 and any change in the touched position are detected by the touch screen panel controller 31. The information concerning the touched position of the user which is detected by the touch screen panel controller 31 is sent to the microcomputer 20. Then, the process proceeds to S52.

At S52, a merged position is recalculated for the processed image (television set image) 53. Specifically, based on the information concerning the touched position of the user, the microcomputer 20 calculates a displacement of the user's finger. By adding this displacement to the marker coordinates, the microcomputer 20 recalculates a position at which to merge the processed image (television set image) 53.

The result of merged position calculation by the microcomputer 20 is sent to the display controller 32. Based on the information which has been sent, the display controller 32 causes the processed image (television set image) 53 to be displayed on the display device 12. Merged position calculation and displaying of the processed image (television set image) 53 are repeatedly performed, whereby the processed image (television set image) 53 is displayed on the display device 12 in a manner of following the swipe operation by the user. Then, the process proceeds to S53.

At S53, it is determined whether or not the coordinates indicating the merged position for the processed image (television set image) 53 (which may hereinafter be referred to as “merging coordinates”) are equal to or less than predefined values. Specifically, the microcomputer 20 determines whether or not the coordinates of an end of the processed image (television set image) 53 (e.g., the left side face of the television set) are equal to or less than predefined coordinates which are previously stored in the RAM 39. The predefined coordinates are coordinates defining the position of the wall illustrated in FIG. 14, for example. If the merging coordinates are equal to or less than predefined values, the processed image (television set image) 53 has not come in contact with the wall. If the merging coordinates are greater than the predefined value, the processed image (television set image) 53 is in contact with or overlaps the wail.

If it is determined that the merging coordinates are greater than the predefined values (Yes from S53), the process proceeds to S54. At 354, the processed image (television set image) 53 is merged at the merging coordinates of the captured image (living room). The microcomputer 20 sends the data concerning the synthesized image to the display controller 32 as display data. The microcomputer 20 also causes this display data to be stored in the RAM 39. Then, the process proceeds to S55.

At S55, the display controller 32 displays an image based on the display data which has been sent. The image displayed here is the image after the move of the processed image (television set image) 53 has occurred.

On the other hand, if it is determined at S53 that the merging coordinates are equal to or less than the predefined values (No from S53), the process proceeds to S56. At S56, the vibrator 13 vibrates to present a tactile sensation to the user. Specifically, if the coordinates of the merged position are determined to be equal to or less than the predefined values, the microcomputer 20 sends vibration data concerning a vibration pattern to the vibration controller 33. Based on the vibration data which has been sent, the vibration controller 33 vibrates the vibrator 13. Since the user is touching the touch screen panel 11, the user is able to detect this vibration. By detecting this vibration, the user knows that the processed image (television set image) 53 cannot be moved any farther. Moreover, as shown in FIG. 14, a star-shaped pattern indicating that the television set has come into contact with the wall may be indicated above the left of the processed image (television set image) 53.

If the processed image (television set image) 53 were to be displayed as if going beyond the wall position, the user would feel oddness. Therefore, once the end of the processed image (television set image) 53 has come into contact with the wall, the microcomputer 20 exerts control so that the processed image (television set image) 53 will not move any farther.

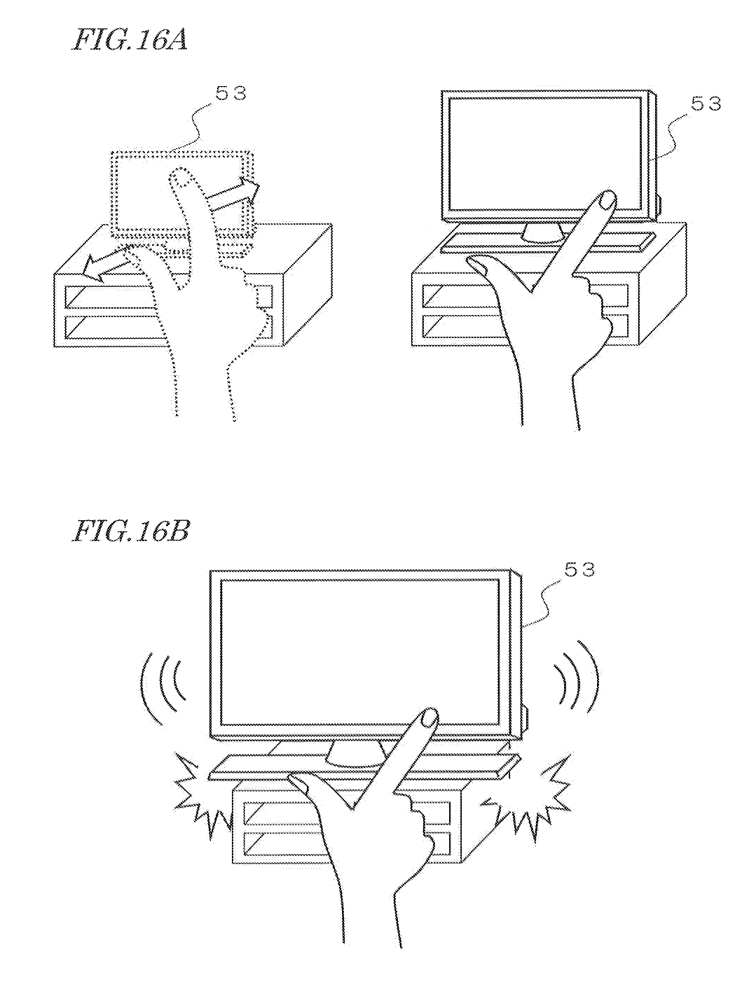

FIGS. 16A and 16B are diagrams showing an exemplary user operation in the present embodiment.

A user who looks at the display image displayed on the display device 12 and thinks that the size of the processed image (television set image) 53 needs to be changed may perform the following operation.

First, the user touches the neighborhood of the processed image (television set image) 53 being displayed on the display device 12 with a thumb and an index finger, and varies the size of the item by changing the interval between the two fingers. The present embodiment envisages that the processed image (television set image) 53 is placed on a television table.

In the present embodiment, if the size of the processed image (television set image) 53 exceeds a predetermined size as the user tries to change the size of the processed image (television set image) 53, alarming vibrations are presented to the user. Such alarms are presented to the user in a plurality of steps.

For example, it is assumed that the item (processed) image is an image of a television set. The television set image includes a television frame portion which is rectangular and a pedestal portion which is shorter in the right-left direction than is the television frame. When the size of the item (processed) image is enlarged such that the size of the television frame portion is about to exceed the image size of the television table, a first alarm is presented. Thereafter, when the size of the pedestal portion of the processed image (television set image) 53 is about to exceed the image size of the television table, a second alarm is presented. In the present embodiment, size change of the item can still occur after the first alarm, up until the second alarm is given. However, once the second alarm is given, size change of the item no longer occurs.

The above process is based on the premise that the microcomputer 20 has distinguished the pattern of the television table from within the captured image. The microcomputer 20 may realize this by recognizing the marker (not shown), and recognizing the pattern of the object (i.e. television table) on which the marker is placed, for example. Alternatively, the user may input a range of the television table.

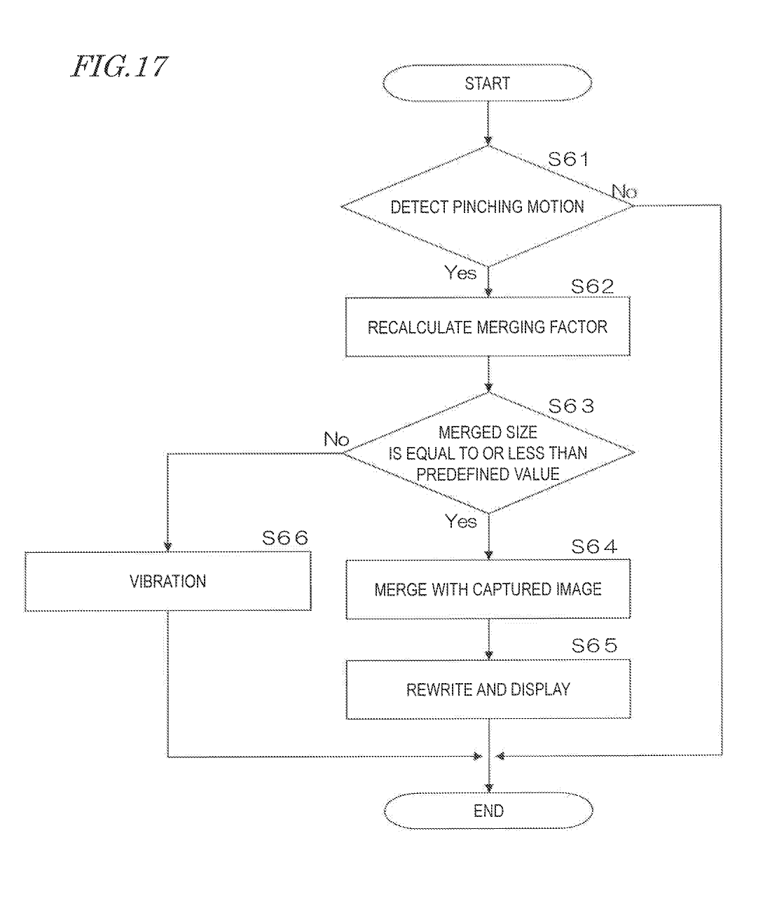

FIG. 17 is a flowchart showing a flow of processes under the user operation shown in FIGS. 16A and 16B.

The process described herein is a process concerning the “various processing” at S13 of the flowchart shown in FIG. 8. If it is determined at S12 in the flowchart shown in FIG. 8 that the user has made a touch, the process proceeds to S61. At S61, it is determined whether the user has made a pinch operation or not. Specifically, the touch screen panel controller 31 detects an amount of change in touched position caused by a pinch operation of the user.

If a pinch operation is detected (Yes from S61), the process proceeds to S62. At S62, based on the amount of change in touched position detected by the touch screen panel controller 31, the microcomputer 20 calculates an amount of pinch. The amount of pinch indicates an amount of change in the interval between fingers during a pinch operation. Based on the finger interval when the user touches with two fingers, any broader finger interval is expressed as a larger amount of pinch, and any narrower finger interval is expressed as a smaller amount of pinch.

Based on the change in amount of pinch, the microcomputer 20 varies the merging factor (i.e., a rate of change in the displayed size of an item). Specifically, if the amount of pinch increases, the microcomputer 20 increases the merging factor; if the amount of pinch decreases, the microcomputer 20 decreases the merging factor. A value obtained by multiplying the displayed processed image (television set image) 53 by the merging factor defines the size after merging (which hereinafter may be simply referred to as the merged size). After the merging factor is calculated, the process proceeds to S63.

At S63, it is determined whether or not the merged size is equal to or less than a predefined value. Specifically, the microcomputer 20 determines whether the size of the processed image (television set image) 53 is equal to or less than the size of the television table. The size of the television table may be previously input by the user. Alternatively, the size of the television table may be calculated from a ratio between the actual dimensions of the marker 50 and the dimensions of the marker 50 appearing in the captured image (living room image) 51. The above process is performed by the microcomputer 20.

If the merged size is determined to be equal to or less than the predefined value (Yes from S63), the process proceeds to S64. At S64, the microcomputer 20 merges the processed image (television set image) 53 having the changed size with the captured image (living room image) 51, thus generating display data. This display data is stored to the RAM 39. Once the display data is generated, the process proceeds to S65.

At S65, the display controller 32 causes the display device 12 to display an image in which the size of the processed image (television set image) 53 is changed, based on the display data (as shown in FIG. 16B).

On the other hand, if S63 finds that the merged size is greater than the predefined value (No from S63), the process proceeds to S66. At S66, the vibrator 13 vibrates to present a tactile sensation to the user. Specifically, if the merged size is determined to be greater than the predefined value, the microcomputer 20 sends vibration data concerning a vibration pattern to the vibration controller 33. Based on the vibration data which has been sent, the vibration controller 33 vibrates the vibrator 13. Since the user is touching the touch screen panel 11, the user is able to detect this vibration.

If a tactile sensation is presented to the user at S66, the process proceeds to S67 and is ended.

Through the above process, the user is able to move the processed image (television set image) 53 which is displayed in the captured image to a desired position. Moreover, the user operation is further facilitated by presenting a variety of vibrations which are associated with different moves of the processed image (television set image) 53.

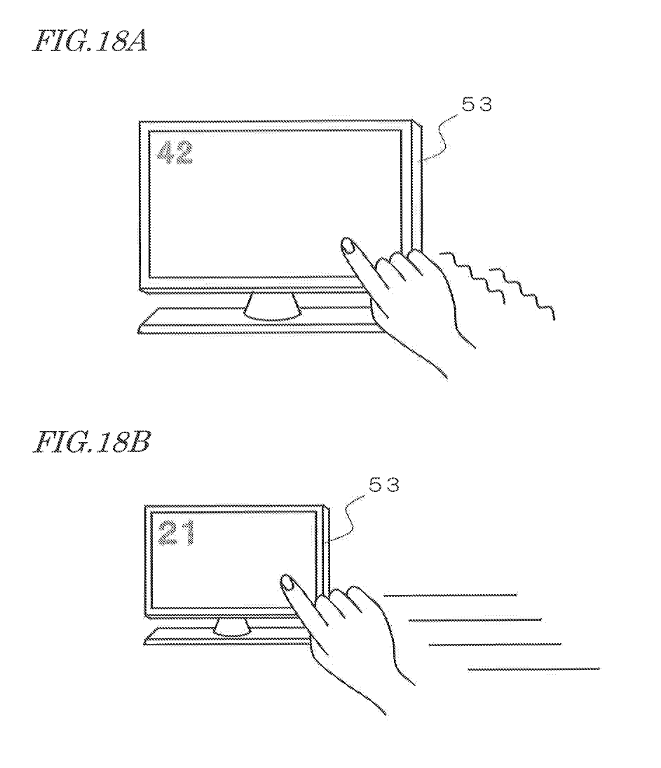

When moving the processed image (television set image) 53, the microcomputer 20 may exert the following control. For example, when moving a television set of a large size as shown in FIG. 18A, a vibration may be presented which increases the friction between the user's finger and the touch screen panel. Or, when moving a television set of a small size as shown in FIG. 18B, the intensity of the vibration may be made weaker than when moving a television set of a large size. Through such control, an enhanced reality can be provided, and also the user is allowed to gain various information.

A vibration which increases the friction between the user's finger and the touch screen panel may chiefly be vibration of a high frequency range in which the Pacinian corpuscle will be stimulated, for example. The Pacinian corpuscle is one of a number of tactoreceptors that are present on the human finger. The Pacinian corpuscle has a relatively high sensitivity, and is stimulated with an indenting amplitude of 2 μm for a vibration of about 80 Hz. If the vibration frequency is lowered to e.g. 10 Hz, the sensitivity decreases and the stimulation threshold increases to 100 μm. The Pacinian corpuscle has a sensitivity distribution that is frequency specific, with the peak sensitivity being at 100 Hz. The microcomputer 20 vibrates the touch screen panel 11 with an amplitude corresponding to the aforementioned frequency. Thus, by stimulating the Pacinian corpuscle, a tactile sensation can be presented to the user as if the friction against the touch screen panel has increased.

Moreover, control may be exerted so that different vibrations are presented depending on the place in which the item such as a television set is disposed. For example, when a television set is disposed in a place of large friction, e.g., a carpet, a vibration which provides an increased friction may be presented when moving the television set. On the other hand, when it is disposed in a place of low friction, e.g., flooring, the vibration may be weakened.

If a level difference or protrusion appears to exist at the place in which the item is to be disposed, control may be exerted so that a vibration is presented as the item passes over it.

### Embodiment 2

In Embodiment 1, the displayed position and displayed dimensions of an item are calculated by using a marker. Instead of a marker, the electronic device of the present embodiment utilizes a piece of furniture which is already placed in the living room to calculate the displayed position and displayed dimensions of an item.

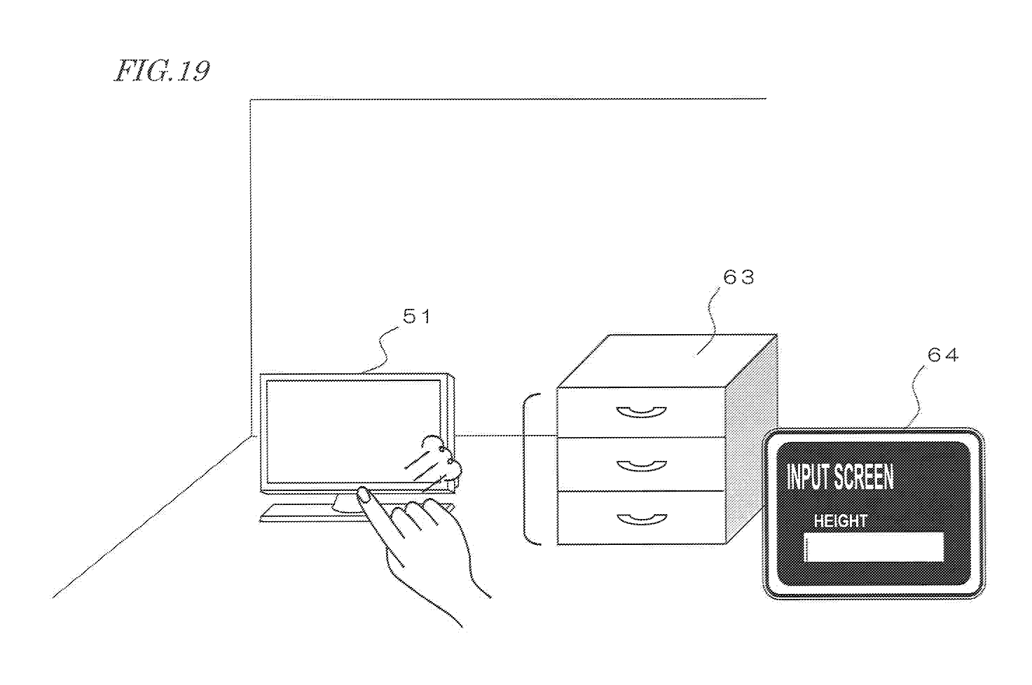

FIG. 19 is a diagram showing an exemplary operation by a user in Embodiment 2.

The user shoots the inside of a room in which an item is to be placed. The image which has been captured is displayed on the display device 12 of the electronic device. The user touches on a place where a piece of furniture having known dimensions is displayed. The microcomputer 20 accepts a touch operation from the user, and displays an input screen 64 in which dimensions of the piece of furniture (reference object 63) that has been recognized by the electronic device are to be input. The user inputs the dimensions of the piece of furniture, which are measured in advance, to the input screen 64. The microcomputer 20 calculates a merging factor from a ratio between the dimensions of the reference object 63 in the captured image data and the user-input dimensions, and causes it to be stored to the RAM 39. Thereafter, the user touches a position at which an item is to be placed. The microcomputer 20 acquires the coordinates of the touch from the touch screen panel controller 31, and calculates coordinates of a merged position. Based on a merging factor 61, the microcomputer applies image processing to the recording image data and generates processed recording image data, which is then stored to the RAM 39. Thereafter, based on the coordinates of the merged position, the processed recording image data is merged with the captured image data, thereby generating display data. The display controller 32 causes this to be displayed on the display device.

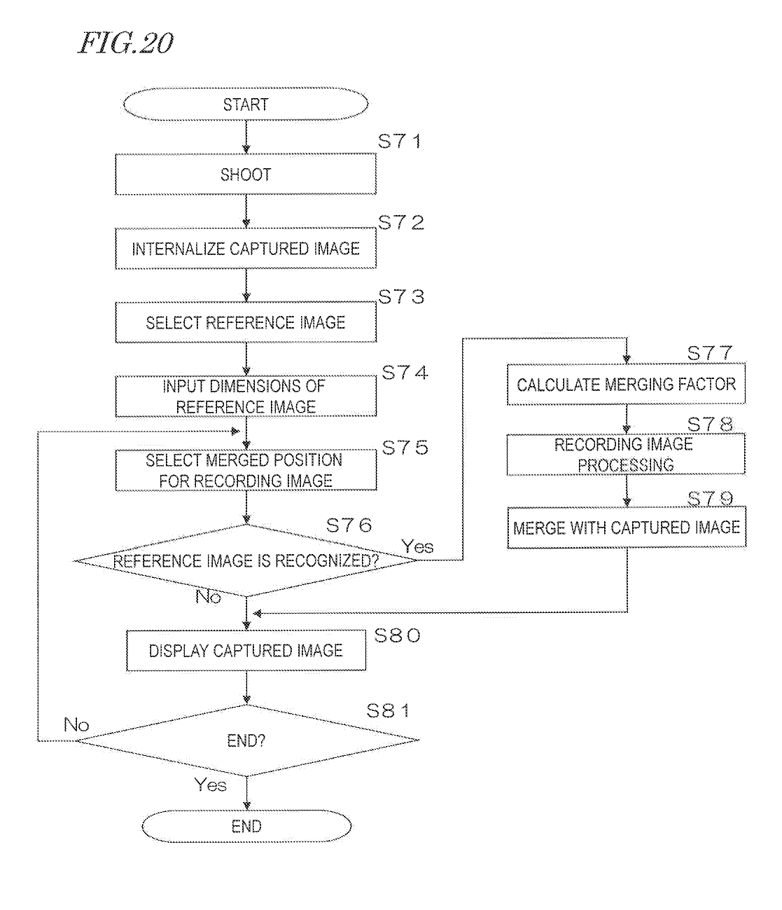

FIG. 20 is a flowchart showing a flow of processes in Embodiment 2, where reference dimensions are input for image synthesis.

The process described herein is a process concerning the “various processing” at S13 of the flowchart shown in FIG. 8. If it is determined at S12 in the flowchart shown in FIG. 8 that the user has made a touch, the process proceeds to S71. At S71, the user performs shooting.

Thereafter, the process proceeds to S72. At S72, the captured image is internalized. Specifically, the microcomputer 20 causes the data of a captured image taken with the camera 15 and the camera controller 35 to be stored to the RAM 39. After internalization of the captured image, the process proceeds to S73.

At S73, the user selects the reference object 63. The reference object 63 is an image which serves as a reference in calculating the dimensions with which the processed image (television set image) 53 is to be displayed, when merging the processed image (television set image) 53 into the captured image. Herein, the image of a chest which is already placed in the room is set as the reference object 63. Specifically, by touching on the chest in the captured image being displayed on the display device 12, the chest image becomes set as the reference object. Once the reference object 63 is set, the process proceeds to S74.

At S74, the microcomputer 20 displays an interface screen for inputting the dimensions of the reference object 63. The user inputs the dimensions of the reference object 63 in an input box of the interface screen. Specifically, when the user selects the reference object 63 at S73, the microcomputer 20 displays an interface screen (dimension input screen) 64 on a portion of the display screen 12 near the reference object 63. The user is able to utilize a software keyboard or a hardware keyboard (neither is shown) to input the dimensions of the chest in the dimension input screen 64, for example. Note that the aforementioned interface screen and the software keyboard or hardware keyboard may be referred to as the interface. Once the input of dimensions by the user is finished, the process proceeds to S75.

At S75, a merged position for the processed image (television set image) 53 is selected. Specifically, when the user touches a position where the processed image (television set image) 53 is to be placed, information of the coordinates of the touched position is sent from the touch screen panel controller 31 to the microcomputer 20. Based on the coordinates of the touched position, the microcomputer 20 calculates coordinates of the merged position, and causes them to be stored to the RAM 39. Once the merged position is selected, the process proceeds to S76.

At S76, recognition of the reference object 63 takes place. Specifically, the microcomputer 20 determines whether the reference object 63 is being displayed in the captured image. If it is determined that the reference object 63 is being displayed, the process proceeds to S77.

At S77, a merging factor is calculated. Specifically, based on a ratio between the actual dimensions of the reference object 63 and its dimensions on the display screen, the microcomputer 20 calculates displayed dimensions for the processed image (television set image) 53. Then, based on the calculated merging factor, the processed image (television set image) 53 is subjected to image processing, e.g., enlargement or reduction (S78), and merged into the captured image (living room image) 51 (S79), whereby display data is generated. The display data is recorded to the RAM 39. Thereafter, at 880, the generated display data is displayed on the display device 12.

On the other hand, if S76 does not recognize the reference object 63, the process proceeds to S80 without performing a merging factor calculation and the like, and the captured image (living room image) 51 is displayed as it is.

If a marker were to be used, the marker would have to be prepared, and its dimension information would need to be retained in advance. The present embodiment, in which the user selects a reference object and then inputs its dimension information, makes it unnecessary to prepare such a marker and dimension information.

### Embodiment 3

In Embodiment 1 or 2, the position at which to merge the processed image (television set image) 53 and its displayed dimensions are calculated by using the marker 50 or the reference object 63. The electronic device of the present embodiment calculates a merged position and displayed dimensions by using a camera which is capable of stereophotography.

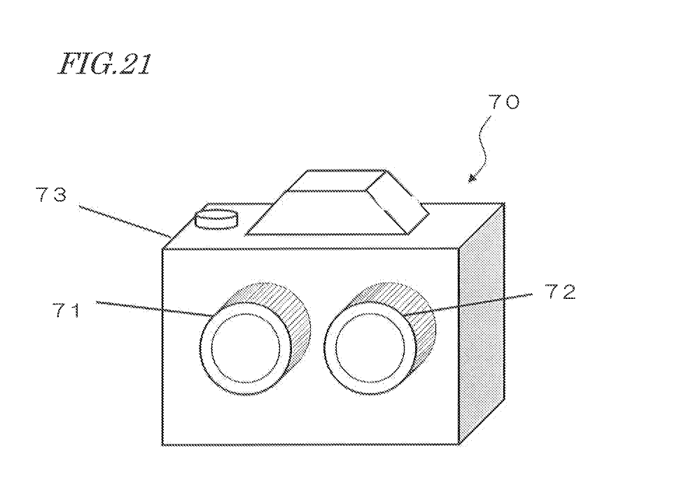

FIG. 21 is a schematic illustration showing a stereo camera 70 which is capable of stereophotography. The stereo camera 70 includes a body 73, a first barrel 71, and a second barrel 72. The first barrel 71 and the second barrel 72 are disposed side by side along the horizontal direction. Since there is parallax between an image which is captured with the first barrel 71 and an image which is captured with the second barrel 72, it is possible to calculate the depth and the like of the captured image by using this parallax information.

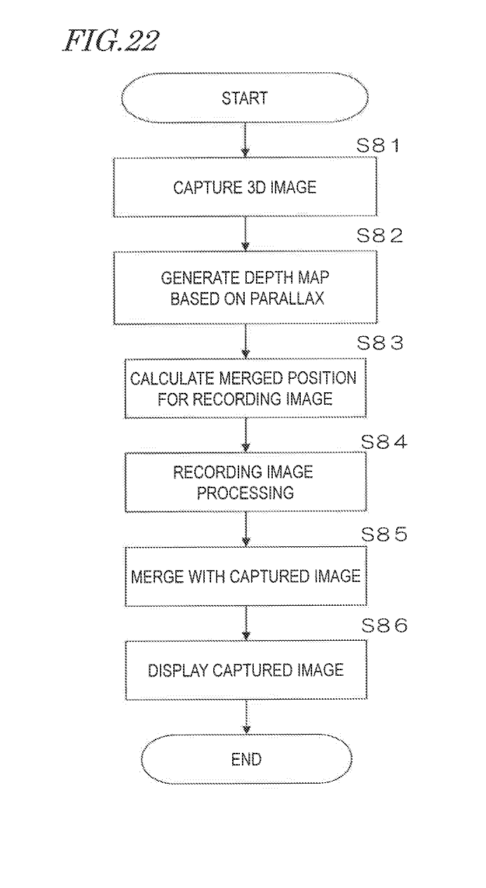

FIG. 22 is a flowchart showing a flow of processes according to Embodiment 3.

The process described herein is a process concerning the “various processing” at S13 of the flowchart shown in FIG. 8. If it is determined at S12 in the flowchart shown in FIG. 8 that the user has made a touch, the process proceeds to S81. At S81, the user performs stereophotography. Parallax occurs between the two images captured with the two barrels. Then, the microcomputer 20 generates a depth map by using the parallax information (S82). The depth map represents information concerning depth dimension at each position, within the captured image.

Next, the user touches a position where an item is to be placed. Based on the coordinates of the touched position and the depth map, the microcomputer 20 calculates a position at which the item is to be merged (S83). Thereafter, recording image processing (S84), merging with the captured image (S85), and displaying of the captured image (S86) are conducted. These processes are similar to the processes described in Embodiments 1 and 2, and their description will not be repeated here.

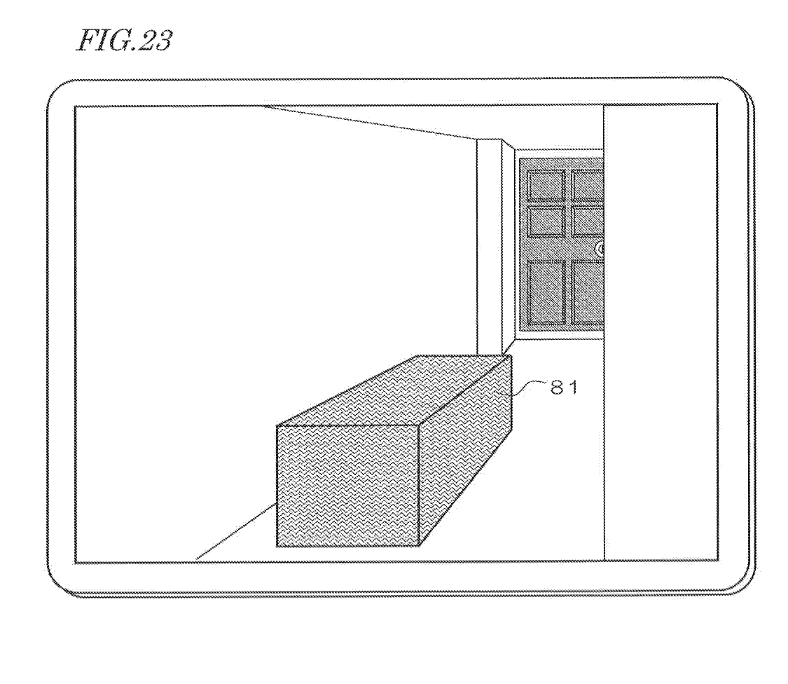

FIG. 23 shows a captured image taken with the stereo camera 70. The captured image is an image taken of a hallway that extends from the entrance to the living room of a user's home. For example, if a piece of furniture 81 purchased by the user is larger than the width of the hallway or the entrance of the home permits, it may be impossible to carry the furniture into the living room. According to the present embodiment, the user is able to perform a simulation as to whether the purchased piece of furniture 81 can be carried into the room. Specifically, by operating the piece of furniture 81 with a finger, the user realizes a simulation of carrying in the piece of furniture. The user may touch the piece of furniture 81 with a finger, and swipe the finger rearward down the hallway, thus moving the piece of furniture 81. The depth map of the captured image has been generated in advance, and thus, based on the depth map information, the piece of furniture 81 receives image processing so that its size reduces toward the rear of the hallway. Moreover, by swiping the finger on the piece of furniture 81 in a circling manner, the user is able to rotate or change the direction of the piece of furniture 81. By making such an operation to move the piece of furniture 81 rearward along the hallway, the user is able to perform a simulation as to whether the piece of furniture can be safely carried in or not.

If a circling operation of the user is detected, the microcomputer 20 infers that a pivot axis exists at the center of the circle of that circling operation, for example. Then, by referring to the depth map, it identifies the direction in which the pivot axis extends. With the depth map, it is possible to identify whether the pivot axis extends in the depth direction or in the right-left direction at a certain depth position. Once the pivot axis is identified, the microcomputer 20 may calculate a merged position, a merging factor, and a merging angle so that the piece of furniture 81 is rotated along that pivot axis.

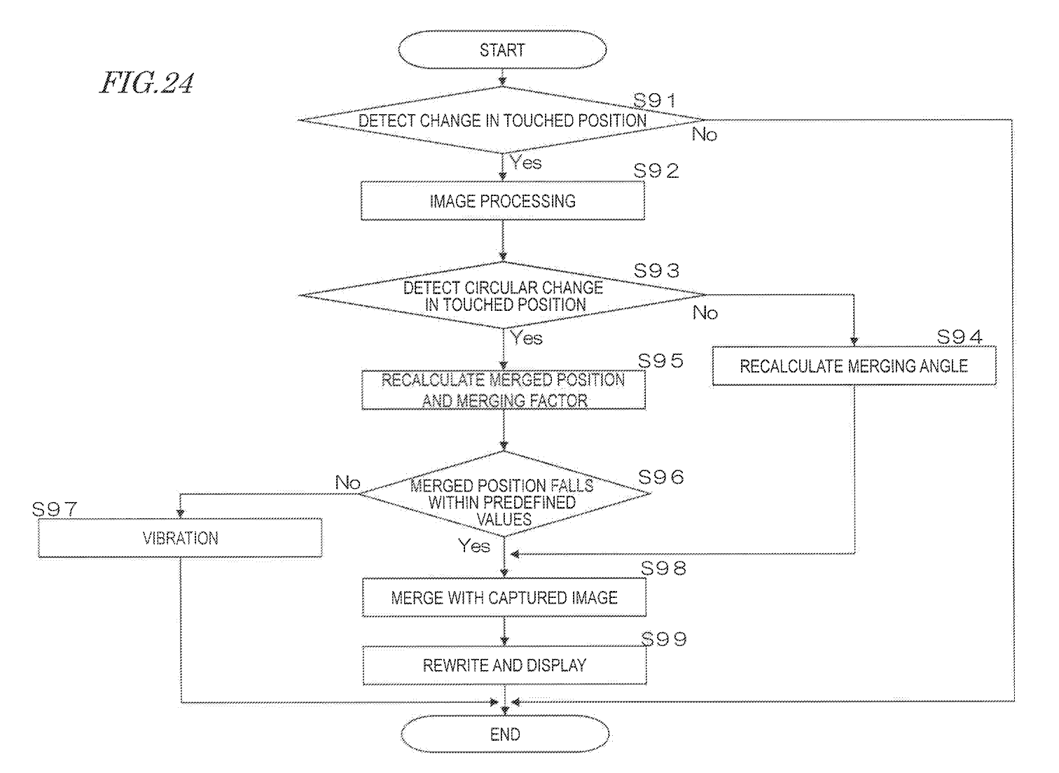

FIG. 24 is a flowchart showing a flow of processes when conducting a simulation of carrying in a piece of furniture.

The process described herein is a process concerning the “various processing” at S13 of the flowchart shown in FIG. 8. If it is determined at S12 in the flowchart shown in FIG. 8 that the user has made a touch, the process proceeds to S91. At S91, a change in the touched position is detected. Specifically, information concerning the touch of the user's finger is sent from the touch screen panel controller 31 to the microcomputer 20. Thereafter, the process proceeds to S92.

At S92, image processing is carried out in accordance with the change in the touched position of the user. Specifically, a merged position and a displaying magnification for the piece of furniture 81 are recalculated. If the change in the touched position of the user occurs in the rearward direction of the hallway, the piece of furniture 81 is being moved rearward, and thus image processing is applied so that the piece of furniture 81 decreases in displayed dimensions. If the change in the touched position of the user is in the lateral direction, the position of the piece of furniture 81 is being shifted laterally, and thus a merged position for the piece of furniture 81 is recalculated. Next, the process proceeds to S93.

At S93, it is detected whether the change in the touched position is a circular change or not. Specifically, information concerning the touch of the user's finger is sent from the touch screen panel con roller 31 to the microcomputer 20. If the change in the touched position of the user constitutes a circular change (Yes from S93), the process proceeds to S95.

At S95, based on the amount of circular change in the touched position of the user, a merging angle at which to merge the piece of furniture 81 is recalculated. After the merging angle is calculated, the piece of furniture 81 is merged into the captured image based on that angle (S96). Thereafter, the synthetic image is displayed on the display device 12 (S97), and the process is ended.

On the other hand, if S93 does not detect a circular change in the touched position (No from S93), the process proceeds to S94. At S94, it is determined whether the merged position of the piece of furniture 81 falls within predefined values. Since the walls, the ceiling, and the like are displayed in the captured image, the simulation of carrying in a piece of furniture will not make sense if the piece of furniture 81 can pass through the walls or the ceiling. Therefore, when the piece of furniture 81 comes into contact with the walls or the ceiling, the electronic device 10 presents a tactile sensation, e.g., vibration, to the user; thus, the user knows that the piece of furniture 81 cannot be moved any farther. In the present embodiment, the aforementioned predefined values are values that define a range in which the piece of furniture 81 is freely movable. Specifically, the range in which the piece of furniture 81 is movable can be calculated by calculating the coordinates of the region in which the walls or the ceiling is not displayed.

At 393, if the microcomputer 20 determines that the position of the piece of furniture 81 falls within the predefined values, the process consecutively proceeds to S96 and S97. On the other hand, if the microcomputer 20 determines that the position of the piece of furniture 81 goes beyond the predefined values, the process proceeds to S98. At S98, information that the position of the piece of furniture 81 has gone outside the predefined values is sent from the microcomputer 20 to the vibration controller 33. Based on the information which has been sent, the vibration controller 33 vibrates the vibrator 13. As this vibration is transmitted to the user's finger, the user is able to know that the piece of furniture 81 has hit the wall or ceiling.

By repeating the above process, the user is able to perform a simulation as to whether the piece of furniture 81 to be purchased can be carried into the living room or other desired room.

### Embodiment 4

The electronic device of the present embodiment differs from the above Embodiments in that depth information within a captured image is calculated by using an autofocus function (which hereinafter may be simply be referred to as AF) of a digital camera.

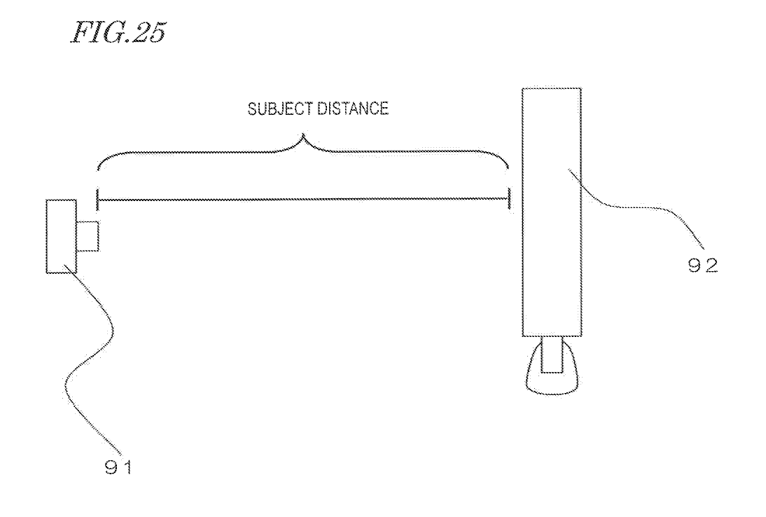

FIG. 25 is a diagram showing the subject distance between the digital camera 91 and the reference object (television set) 92. The digital camera 91 includes an AF lens not shown. As shown in the figure, by detecting a position at which the digital camera 91 focuses, it is possible to calculate the distance from the digital camera 91 to the reference object (television set) 92. This distance can be used to calculate a depth map within the captured image. Using this depth map, the position at which a television set to be purchased or the like is going to be placed can be calculated.

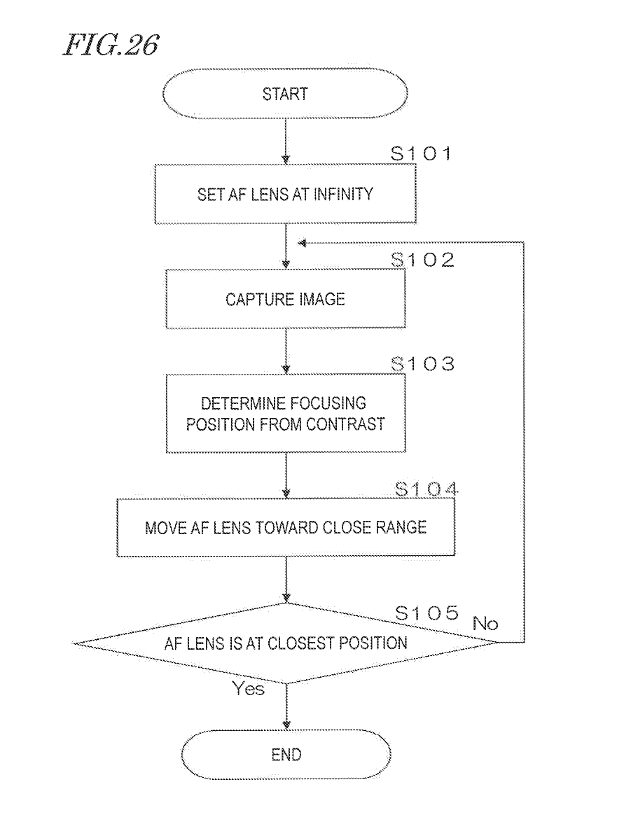

FIG. 26 is a flowchart showing a flow of processes when using a depth map under an AF function.

When the power of the digital camera 91 is activated, the AF lens is moved at 3101 so that the focal length of the AF lens is infinity. Thereafter, shooting with the digital camera 91 is begun at S102. When shooting is begun, at S103, a focusing position is determined from the contrast of the image which has been captured by the digital camera 91. Information concerning the focusing position is sent to the microcomputer 20, and the microcomputer 20 generates a depth map based on the information concerning the focusing position. When the shooting is finished, the AF lens is moved toward the close range at S104. Thereafter, at S105, it is determined whether the AF lens is disposed at the closest position. If the AF lens is at the closest position (Yes from S105), the process is ended. If the AF lens is not at the closest position (No from S105), the process returns to S102 and a focusing position is again detected.

### Embodiment 5

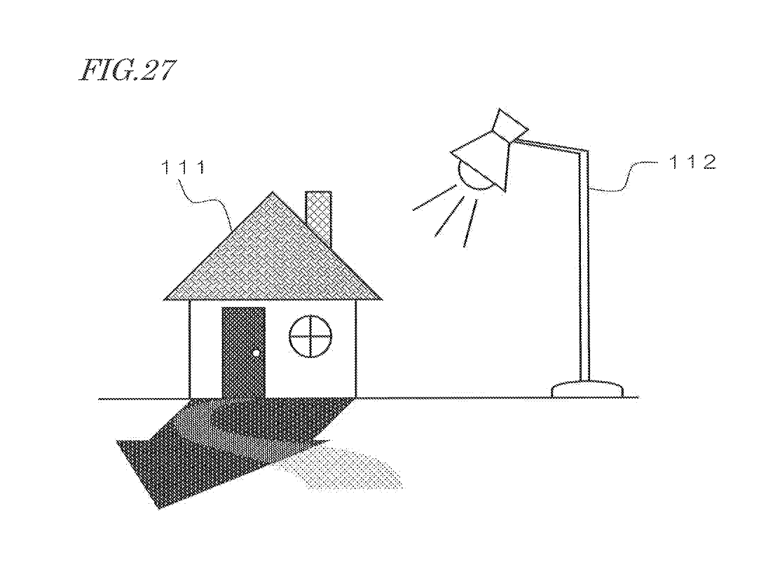

All of the above Embodiments are illustrated by using a captured image which is obtained by shooting the inside of a room, but the captured image is not limited thereto. For example, it may be an outdoor image as shown in FIG. 27. For example, in the case where an outside light 112 is to be placed around a house 111, a captured image featuring the house 111 may be internalized into the electronic device, and the outside light 112 may be merged thereon. As in the above Embodiments, by freely changing the position of the outside light 112, it is possible to conduct a simulation as to which position and shape a shade of the house created by the light from the outside light 112 may take.

### Summary of Embodiments

As described above, the electronic device 10 includes the display device 12, the touch screen panel 11, and the microcomputer 20 (which is an example of a control circuit). The display device 12 is capable of displaying a captured image and an item image. The touch screen panel 11 accepts a touch operation from a user. Based on the position and size of a reference object in the captured image, the microcomputer 20 calculates a displayed position and a displayed size for the item image, merges the item image into the captured image to generate a synthetic image, and causes the synthetic image to be displayed on the display device 12. Moreover, in accordance with the user's touch operation on the touch screen panel, the microcomputer 20 edits the displayed position and displayed size of the merged item image.

Such construction allows the user to easily change the merged position of the item image within the synthetic image.

Moreover, the electronic device 10 includes a vibrator 13 (tactile sensation unit) for presenting a tactile information to the user in response to a user operation.

Such construction allows the user to know what sort of operation he or she has made.

The reference object may be a marker which contains marker information that is associated with the item image. Then, the electronic device 10 may further include a storage section in which the marker information and item image information containing the item image are stored.

With such construction, the electronic device 10 is able to display an item image (e.g., a television set) in a position within the captured image (e.g., a living room) at which the marker is placed. As a result, the user is able to ensure harmony between the television set to be purchased and the living room.

Moreover, the marker information may contain actual-size information of the marker, and the item image information may contain actual-size information of the item image. Then, based on the displayed size of the marker 50 appearing on the display device 12 and the actual size of the marker 50, the microcomputer 20 may calculate a merging ratio, and calculate a displayed position and a displayed size for the item image based on the merging ratio and the actual-size information of the item image.

With such construction, the size of the item image (e.g., a television set) can be adapted to the size of the captured image (e.g., a living room), whereby the item image (e.g., a television set) can be displayed in the captured image (e.g., a living room) without oddness. As a result, the user is able to ensure harmony between the television set to be purchased and the living room.

Moreover, the microcomputer 20 may calculate a displayed position and a displayed size for any object within the captured image based on the displayed position and displayed size of the marker 50.

Objects within the captured image may be pieces of furniture that are already placed in the living room, the walls, and the like, for example.

With such construction, the position or size of pieces of furniture that are already placed in the living room, as well as the broadness, depth, and the like of the living room, can be calculated, for example.

Moreover, when the displayed position of the item image is changed based on a touch operation by the user, the microcomputer 20 may control the vibrator to present a tactile sensation to the user based on whether displayed position coordinates concerning the displayed position of the item image have exceeded threshold values or not.

Moreover, the threshold values may be calculated from the displayed position coordinates of the displayed position of an object within the captured image. Then, if the displayed position coordinates of the item image have exceeded the threshold values, the microcomputer 20 may control the tactile sensation unit to present a tactile sensation to the user.

With such construction, the user is able to know through the vibration that the item image such as a television set has protruded from the television table or hit the wall, for example.

Moreover, the reference object may be at least one object that is contained within the captured image. A storage section which stores reference object information, which is information concerning the reference object, and item image information containing the item image, may be further included.

With such construction, the size and position of the item image can be calculated based on an object that is contained within the captured image, without using a marker 50.

Moreover, the electronic device 10 may further include a reception section which accepts an input of actual-size data of the reference object and a storage section which stores actual-size data of the accepted reference object and item image information containing the item image.

With such construction, the size and position of the item image can be calculated by using input data.

Moreover, the reference object information may contain actual-size information of the reference object. The item image information may contain actual-size information of the item image. Then, the microcomputer 20 may calculate a merging ratio based on the displayed size of the reference object appearing on the display device and the actual size of the reference object, and calculate a displayed position and a displayed size for the item image based on the merging ratio and the actual-size information of the item image.

With such construction, it is possible to calculate a displayed size for the item image by using the reference object.

Moreover, the microcomputer 20 may calculate a displayed position and a displayed size for any other object in the captured image based on the displayed position and displayed size of the reference object.

Moreover, when the displayed position of the item image is changed based on a touch operation by the user, the microcomputer 20 may control the vibrator to present a tactile sensation to the user based on whether the displayed position coordinates concerning the displayed position of the item image have exceeded threshold values or not.

Moreover, the vibrator may present a tactile sensation to the user based on a change in the displayed size of the item image.

Moreover, the item image information may contain weight information of the item, and the vibrator may vary the vibration pattern based on the weight information of the item.

Moreover, the captured image may be an image which is captured with a stereo camera which is capable of stereophotography, the image being composed of an image for the left eye and an image for the right eye. Then, the storage section may store parallax information which is calculated from a reference object within the image for the left eye and the reference object within the image for the right eye. Then, based on the parallax information, the microcomputer 20 may calculate a displayed position for the reference object.

Moreover, the captured image may be an image which is captured by an imaging device which is capable of automatically detecting a focusing position of a subject, which may include the reference object. Then, the storage section may store distance information from the imaging device to the reference object which is calculated based on the focusing position of the reference object. Then, based on the distance information, the microcomputer 20 may calculate a displayed position for the reference object.

### Other Embodiments

Although Embodiments 1 to 5 have been illustrated, the present disclosure is not limited thereto. Therefore, other embodiments of the present disclosure will be outlined below.

The notification section is not limited to the vibrator 13. For example, the notification section may be a loudspeaker which gives information to the user in the form of an audio. Alternatively, the notification section may have a construction for giving information to the user with light. Such construction can be realized through control of the display device 12 by the display controller 32, for example. Alternatively, the notification section may have a construction for giving information to the user in the form of heat or an electric shock.

Although Embodiments 1 to 5 illustrate a tablet-type information terminal device as an example electronic device, the electronic device is not limited thereto. It may be any electronic device having a touch screen panel, e.g., a mobile phone, a PDA, a game machine, a car navigation system, or an ATM.

Although Embodiments 1 to 5 illustrate the touch screen panel as a member covering the entire display surface of the display device 12, this is not a limitation. For example, a touch screen panel function may be provided only in a central portion of the display surface, while the peripheral portion may not be covered by anything that confers a touch screen panel function. In other words, the touch screen panel may at least cover the input operation area of the display device.

The present disclosure is useful for an electronic device which permits touch operation by a user, for example.

While the present disclosure has been described with respect to exemplary embodiments thereof, it will be apparent to those skilled in the art that the disclosure may be modified in numerous ways and may assume many embodiments other than those specifically described above. Accordingly, it is intended by the appended claims to cover all modifications of the disclosure that fall within the true spirit and scope of the invention.

What is claimed is:

1. An electronic device comprising:
a display device capable of displaying a captured image and an item image;
a touch screen panel configured to accept an operation by a user; and
a control circuit configured to calculate a displayed position and a displayed size for the item image based on a position and a size of a reference object in the captured image, configured to generate a synthetic image in which the item image is merged with the captured image, and configured to cause the display device to display the synthetic image, the control circuit generating a synthetic image in which the displayed position and displayed size of the item image are adjusted in accordance with an operation on the touch screen panel by the user.

2. The electronic device of claim 1, further comprising a tactile sensation unit configured to present a tactile information to the user in accordance with an operation by the user.

3. The electronic device of claim 1, wherein
the reference object is a marker containing marker information which is associated with the item image, the electronic device further comprising:
a storage section storing the marker information and item image information containing the item image.

4. The electronic device of claim 3, wherein,
the marker information contains actual-size information of the marker;
the item image information contains actual-size information of the item image; and
the control circuit calculates a merging ratio based on a displayed size of the marker appearing on the display device and an actual size of the marker, and calculates a displayed position and a displayed size for the item image based on the merging ratio and the actual-size information of the item image.

5. The electronic device of claim 4, wherein the control circuit calculates a displayed position and a displayed size of an object in the captured image based on a displayed position and the displayed size of the marker.

6. The electronic device of claim 2, wherein, when the displayed position of the item image in the synthetic image is changed based on an operation by the user, the control circuit controls the tactile sensation unit to present a tactile sensation to the user based on whether a threshold value is exceeded by a displayed position coordinate concerning the displayed position of the item image or not.

7. The electronic device of claim 6, wherein,
the threshold value is calculated from a displayed position coordinate concerning the displayed position of an object in the captured image; and
if the displayed position coordinate of the item image exceeds the threshold value, the control circuit controls the tactile sensation unit to present a tactile sensation to the user.

8. The electronic device of claim 1, wherein
the reference object is at least one object contained in the captured image, the electronic device further comprising
a storage section storing reference object information concerning the reference object and item image information containing the item image.

9. The electronic device of claim 1, wherein,
the reference object is at least one object contained in the captured image, the electronic device further comprising:
an interface for accepting an input of actual-size data of the reference object; and
a storage section storing the accepted actual-size data of the reference object and the item image information containing the item image.

10. The electronic device of claim 8, wherein,
the reference object information contains actual-size information of the reference object;
the item image information contains actual-size information of the item image; and
the control circuit calculates a merging ratio based on a displayed size of the reference object appearing on the display device and an actual size of the reference object and calculates a displayed position and a displayed size for the item image based on the merging ratio and the actual-size information of the item image.

11. The electronic device of claim 8, wherein the control circuit calculates a displayed position and a displayed size for another object in the captured image based on a displayed position and a displayed size of the reference object.

12. The electronic device of claim is, further comprising a tactile sensation unit configured to present a tactile information to the user in accordance with an operation by the user,
wherein, when the displayed position of the item image in the synthetic image is changed based on an operation by the user, the control circuit controls the tactile sensation unit to present a tactile sensation to the user based on whether a threshold value is exceeded by a displayed position coordinate concerning the displayed position of the item image or not.

13. The electronic device of claim 2, wherein the tactile sensation unit presents a tactile sensation to the user in accordance with change in the displayed size of the item image.

14. The electronic device of claim 3, further comprising a tactile sensation unit configured to present a tactile information to the user in accordance with an operation by the user,
wherein,
the item image information contains weight information of the item; and
the tactile sensation unit varies a tactile sensation presented to the user based on the weight information of the item.

15. The electronic device of claim 1, wherein,
the captured image is an image composed of an image for a left eye and an image for a right eye which are captured with a stereo camera capable of stereophotography;
the storage section stores parallax information which is calculated from the reference object in the image for the left eye and the reference object in the image for the right eye; and
the control circuit calculates a displayed position for the reference object based on the parallax information.

16. The electronic device of claim 1, wherein,
the captured image is an image captured with an imaging device capable of detecting a focusing position of a subject, the subject including the reference object;
the storage section stores distance information from the imaging device to the reference object, the distance information being calculated based on a focusing position of the reference object; and
the control circuit calculates a displayed position for the reference object based on the distance information.

17. An editing method of a synthetic image comprising:
calculating a displayed position and a displayed size for an item image based on a position and a size of a reference object in the captured image;
generating a synthetic image by merging the item image in the captured image;
causing the display device to display the synthetic image; and
changing the displayed position and displayed size of the merged item image in accordance with an operation on the touch screen panel by the user.

18. The editing method of a synthetic image of claim 17, further comprising presenting a tactile sensation to the user based on the operation by the user.
